(19) United States
(12) Patent Application Publication
(10) Pub. No.: US 2025/0326447 A1
(43) Pub. Date: Oct. 23, 2025

(54) FAIRING SYSTEM FOR AFT-END DRAG REDUCTION ON VEHICLES WITH A BOX-SHAPED ENCLOSURE

(71) Applicant: Nova Aerospace Structures Ltd., Middle Sackville (CA)

(72) Inventor: Nicholas Seminatore, Middle Sackville, NS (CA)

(73) Assignee: Nova Aerospace Structures Ltd., Middle Sackville, NS (CA)

(21) Appl. No.: 19/073,830

(22) Filed: Mar. 7, 2025

(30) Foreign Application Priority Data
Apr. 17, 2024 (CA) 3235507

(51) Int. Cl. B62D 35/00

(52) U.S. Cl. CPC B62D 35/004

(57) ABSTRACT

A fairing system for aft-end drag reduction on a vehicle with a box-shaped enclosure is provided. The fairing system comprises a substantially flat base adapted to mount to an aft-end of the vehicle. A streamlined body is mounted to the base, the body comprising a first and a second flexible skin forming a first and a second portion of an outer surface of the body that extends rearwardly from the aft-end when deployed and is substantially flat when collapsed. In other embodiments the fairing system comprises two wing-shaped bodies that are pivotally movable between a retracted position with the wing-shaped bodies being oriented substantially parallel to the aft-end of the vehicle and a deployed position with the wing-shaped bodies being oriented rearwardly and inwardly.

### CROSS-REFERENCE TO RELATED APPLICATION

The present application claims priority to Canadian patent application 3,235,507, filed on Apr. 17, 2024, the entire contents of which are hereby incorporated by reference.

### FIELD

The present invention relates to aerodynamic fairing, and more particularly to a fairing system for aft-end drag reduction on vehicles with a box-shaped enclosure.

### BACKGROUND

Reducing drag in vehicles with box-shaped enclosures is of great importance as fuel economy becomes an increasingly large consideration in the overall design of a vehicle and/or its associated enclosure. As the speed of the vehicle increases, the amount of fuel needed to move the vehicle also increases due to the greater energy required to overcome the drag. For example, for vehicles with a box-shaped enclosure travelling at speeds above 40 mph, 50% or more of the total fuel consumption of the vehicle's engine is used to overcome drag. Therefore, even a small reduction in the drag experienced by a vehicle with a box shaped enclosure travelling at highway speeds can result in a significant improvement in fuel economy.

Typically, heavy-duty vehicles such as, for example, tractor-trailers (also known as semi tractors, tractors, class 8 long haul trucks, 18-wheelers, semis, etc.) have cargo enclosures with a tall and wide box-shaped profile that creates a significant amount of drag.

Various efforts have been made to reduce drag of heavy-duty vehicles such as, for example, streamlining the front of the tractor, providing add-ons for directing the air flow around the gap between tractor and the trailer, streamlining the air flow at the front of the trailer, and streamlining the undercarriage of the trailer, which resulted in a considerable reduction of drag.

However, approximately 25% of the drag of a heavy-duty vehicle moving at highway speeds is generated at the aft-end of the vehicle where a region of recirculating flow (called a wake in aerodynamics) forms immediately behind the flat rectangular aft surface of the vehicle (called a blunt body in aerodynamics) which is accompanied by flow separation, vortex generation, and turbulence.

Present day fairing systems for reducing drag generated at the aft-end of the vehicle typically comprise extensions or flaps mounted to the aft-end and extending from the sides, the top, and the bottom of the cargo enclosure rearwardly and inwardly. Unfortunately, these systems still generate a considerable wake and, therefore, provide only a limited drag reduction. Due to their complexity these systems require permanent installation, thus making it impossible to move a system from one vehicle to another which can cause problems for smaller businesses that may operate their vehicles less frequently by rendering the purchase of multiple systems uneconomic.

Furthermore, the extensions or flaps of these systems extend a considerable length from the aft-end, thus substantially affecting the maneuverability in tight spaces such as urban areas or loading docks. To overcome this problem, some of these systems can be moved, manually or automatically, from a retracted position to a deployed position and vice versa, adding further complexity.

It is desirable to provide a fairing system for aft-end drag reduction on vehicles with a box-shaped enclosure that substantially reduces the size of the wake and aft-end drag associated therewith.

It is also desirable to provide a fairing system for aft-end drag reduction on vehicles with a box-shaped enclosure comprising a streamlined body extending rearwardly from the aft-end of the vehicle that is movable from a retracted position to a deployed position and vice versa.

It is also desirable to provide a fairing system for aft-end drag reduction on vehicles with a box-shaped enclosure comprising a streamlined body extending rearwardly from the aft-end of the vehicle that is automatically movable from a retracted position to a deployed position and vice versa.

It is also desirable to provide a fairing system for aft-end drag reduction on vehicles with a box-shaped enclosure that is easily attached to/removed from the aft-end of the vehicle.

It is also desirable to provide a fairing system for aft-end drag reduction on vehicles with a box-shaped enclosure that is compatible with different sizes of vehicles for enabling easy retro-fitting of existing vehicles.

### SUMMARY

Accordingly, one object of the present invention is to provide a fairing system for aft-end drag reduction on vehicles with a box-shaped enclosure that substantially reduces the size of the wake and aft-end drag associated therewith.

Another object of the present invention is to provide a fairing system for aft-end drag reduction on vehicles with a box-shaped enclosure comprising a streamlined body extending rearwardly from the aft-end of the vehicle that is movable from a retracted position to a deployed position and vice versa.

Another object of the present invention is to provide a fairing system for aft-end drag reduction on vehicles with a box-shaped enclosure comprising a streamlined body extending rearwardly from the aft-end of the vehicle that is automatically movable from a retracted position to a deployed position and vice versa.

Another object of the present invention is to provide a fairing system for aft-end drag reduction on vehicles with a box-shaped enclosure that is easily attached to/removed from the aft-end of the vehicle.

Another object of the present invention is to provide a fairing system for aft-end drag reduction on vehicles with a box-shaped enclosure that is compatible with different sizes of vehicles for enabling easy retro-fitting of existing vehicles.

According to one aspect of the present invention, there is provided a fairing system for aft-end drag reduction on a vehicle with a box-shaped enclosure. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms.

According to the aspect of the present invention, there is provided a fairing system for aft-end drag reduction on a vehicle with a box-shaped enclosure. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. The base comprises a first and a second portion for being mounted to a respective left hand side and right hand side door of the vehicle. Each of the first and the second base portion is adapted for being mounted to the respective left hand side and right hand side door via apertures disposed therein at predetermined locations and bolts placed therethrough. The bolts are mounted to each of the first and the second base portion and wherein the bolts are screw bolts secured using screw nuts or comprise bores for accommodating a respective quick release pin therethrough.

According to the aspect of the present invention, there is provided a fairing system for aft-end drag reduction on a vehicle with a box-shaped enclosure. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. The base comprises a first and a second portion for being mounted to a respective left hand side and right hand side door of the vehicle. The streamlined body is adapted to form a dome with approximately a first half of the dome extending rearwardly from the left hand side door and approximately a second half of the dome extending rearwardly from the right hand side door.

According to the aspect of the present invention, there is provided a fairing system for aft-end drag reduction on a vehicle with a box-shaped enclosure. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. The base comprises a first and a second portion for being mounted to a respective left hand side and right hand side door of the vehicle. Each of the first and the second flexible skin comprises: a substantially flat bottom portion mounted to the respective first and second base portion; a curved top portion forming the outer surface of the respective first and second half of the dome; and, a substantially flat wall portion connected to the respective bottom portion and top portion such that the wall is oriented substantially perpendicular to the bottom portion when deployed and wherein each of the first and the second flexible skin forms a substantially airtight enclosure. Means for providing pressurized air are connected to each of the first and the second flexible skin. Each of the a first and the second flexible skin comprises at least a tether mounted thereto for providing rigidity to the respective first and second half of the dome.

According to the aspect of the present invention, there is provided a fairing system for aft-end drag reduction on a vehicle with a box-shaped enclosure. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. At least a processor is connected to the first and the second drive mechanism and connected to a speed sensor. The at least a processor is adapted for receiving data indicative of a speed of the vehicle and for providing power to the first and the second drive mechanism in dependence thereupon.

According to the aspect of the present invention, there is provided a fairing system for aft-end drag reduction on a vehicle with a box-shaped enclosure. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. At least a processor is connected to the first and the second drive mechanism and connected to a speed sensor. The at least a processor is adapted for receiving data indicative of a speed of the vehicle and for providing power to the first and the second drive mechanism in dependence thereupon. A temperature sensor is connected to the at least a processor. The temperature sensor senses an ambient temperature and provides temperature data in dependence thereupon. The at least a processor is adapted for providing power to the first and the second drive mechanism in dependence upon the temperature data. Optionally, a temperature sensor connected to the at least a processor, the temperature sensor for sensing an ambient temperature and providing temperature data in dependence thereupon; and, means for preventing ice-buildup on the outer surface of the streamlined body are connected to the at least a processor and the at least a processor is adapted for providing power to the means for preventing ice-buildup in dependence upon the temperature data.

According to the aspect of the present invention, there is provided a method for reducing aft-end drag on a vehicle with a box-shaped enclosure. A fairing system is provided. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. At least a processor is connected to the first and the second drive mechanism and connected to a speed sensor. The at least a processor is adapted for receiving data indicative of a speed of the vehicle and for providing power to the first and the second drive mechanism in dependence thereupon.

The first and second support boom are moved into the deployed position when the speed of the vehicle is above a predetermined first threshold speed.

According to the aspect of the present invention, there is provided a method for reducing aft-end drag on a vehicle with a box-shaped enclosure. A fairing system is provided. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. At least a processor is connected to the first and the second drive mechanism and connected to a speed sensor. The at least a processor is adapted for receiving data indicative of a speed of the vehicle and for providing power to the first and the second drive mechanism in dependence thereupon.

The first and second support boom are moved into the deployed position when the speed of the vehicle is above a predetermined first threshold speed. The first and second support boom are moved into the collapsed position when the speed of the vehicle is below a predetermined second threshold speed. Optionally, the first and second support boom are moved into the collapsed position when the speed of the vehicle is below a predetermined second threshold speed for a predetermined period of time.

According to the aspect of the present invention, there is provided a method for reducing aft-end drag on a vehicle with a box-shaped enclosure. A fairing system is provided. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. At least a processor is connected to the first and the second drive mechanism and connected to a speed sensor. The at least a processor is adapted for receiving data indicative of a speed of the vehicle and for providing power to the first and the second drive mechanism in dependence thereupon.

The first and second support boom are moved into the deployed position when the speed of the vehicle is above a predetermined first threshold speed. The fairing system comprises a temperature sensor connected to the at least a processor. The temperature sensor senses an ambient temperature and provides temperature data in dependence thereupon. The first and second support boom are being prevented from being moved into the deployed position when the ambient temperature is below a predetermined threshold temperature or are moved into the collapsed position when the ambient temperature is below a predetermined threshold temperature. Optionally, the first and second support boom are moved into the collapsed position when the ambient temperature is below a predetermined threshold temperature for a predetermined period of time.

According to the aspect of the present invention, there is provided a method for reducing aft-end drag on a vehicle with a box-shaped enclosure. A fairing system is provided. The fairing system comprises a substantially flat base adapted for being mounted to an aft-end of the vehicle. A streamlined body is mounted to the base. The streamlined body comprises a first and a second flexible skin forming a first and a second portion of an outer surface of the streamlined body that extends rearwardly from the aft-end when deployed and is substantially flat when collapsed. A first and a second curved support boom are mounted to the first and the second skin, respectively. The support booms are pivotally movable mounted to the base such that the support booms are oriented substantially perpendicular to the base in the deployed position and substantially parallel to the base in the collapsed position. A first and a second drive mechanism are mounted to the base and connected to the first and second support boom, respectively. The drive mechanisms pivotally move the respective support booms. At least a processor is connected to the first and the second drive mechanism and connected to a speed sensor. The at least a processor is adapted for receiving data indicative of a speed of the vehicle and for providing power to the first and the second drive mechanism in dependence thereupon.

The first and second support boom are moved into the deployed position when the speed of the vehicle is above a predetermined first threshold speed. The fairing system comprises a temperature sensor connected to the at least a processor. The temperature sensor senses an ambient temperature and provides temperature data in dependence thereupon. Means for preventing ice-buildup on the outer surface of the streamlined body are connected to the processor. The means for preventing ice-buildup is activated when the ambient temperature is below a predetermined threshold temperature. Optionally, the means for preventing ice-buildup is activated when the ambient temperature is below a predetermined threshold temperature for a predetermined period of time.

According to the aspect of the present invention, there is provided another fairing system for aft-end drag reduction on a vehicle with a box-shaped enclosure. The other fairing system comprises a substantially flat base that is adapted for being mounted to an aft-end of the vehicle.

The other fairing system further comprises a first and a second wing-shaped body. A leading edge portion of each of the first and the second wing-shaped body is pivotally movable mounted to the base in proximity to a respective left hand side edge and right hand side edge of the vehicle. Each of the first and the second wing-shaped body is movable between a retracted position with the first and the second wing-shaped body being oriented substantially parallel to the aft-end of the vehicle and a deployed position with the first and the second wing-shaped body being oriented rearwardly and inwardly. The leading edge portion of each of the first and the second wing-shaped body is placed such that there is a predetermined gap between the same and the aft-end of the vehicle for enabling an airflow therethrough and along an inside surface of each of the first and the second wing-shaped body. A support structure is mounted to the base and each of the first and the second wing-shaped body. The support structure secures the first and the second wing-shaped body to the base and enables moving of the first and the second wing-shaped body between the retracted position and the deployed position. The base comprises a first and a second portion, the first and the second portion being adapted for being mounted to a respective left hand side and right hand side door of the vehicle.

According to the aspect of the present invention, there is provided another fairing system for aft-end drag reduction on a vehicle with a box-shaped enclosure. The other fairing system comprises a base adapted for being mounted to an aft-end of the box-shaped enclosure and a first and a second wing-shaped body. A leading edge portion of each of the first and second wing-shaped body is pivotally movable mounted to the base in proximity to a respective left hand side and right hand side edge of the box-shaped enclosure such that each of the first and second wing-shaped body is movable between a retracted position with each of the first and second wing-shaped body being oriented approximately parallel to the aft-end of the box-shaped enclosure and a deployed position with each of the first and second wing-shaped body being oriented rearwardly and inwardly. A first and a second support strut is pivotally movable mounted to the base at a first end thereof and linearly movable mounted to the respective first and second wing-shaped body at a second end thereof. A first and a second linear actuator is connected to the second end of the respective first and second support strut. The first and second linear actuator are mounted to the respective first and second wing-shaped body. The first and second linear actuator linearly moves the second end of the respective first and second support strut between the retracted position and the deployed position.

An advantage of the present invention is that it provides a fairing system for aft-end drag reduction on vehicles with a box-shaped enclosure that substantially reduces the size of the wake and aft-end drag associated therewith.

A further advantage of the present invention is that it provides a fairing system for aft-end drag reduction on vehicles with a box-shaped enclosure comprising a streamlined body extending rearwardly from the aft-end of the vehicle that is movable from a retracted position to a deployed position and vice versa.

A further advantage of the present invention is that it provides a fairing system for aft-end drag reduction on vehicles with a box-shaped enclosure comprising a streamlined body extending rearwardly from the aft-end of the vehicle that is automatically movable from a retracted position to a deployed position and vice versa.

A further advantage of the present invention is that it provides a fairing system for aft-end drag reduction on vehicles with a box-shaped enclosure that is easily attached to/removed from the aft-end of the vehicle.

A further advantage of the present invention is that it provides a fairing system for aft-end drag reduction on vehicles with a box-shaped enclosure that is compatible with different sizes of vehicles for enabling easy retro-fitting of existing vehicles.

### BRIEF DESCRIPTION OF THE DRAWINGS

A preferred embodiment of the present invention is described below with reference to the accompanying drawings, in which:

FIGS. 1 to 3 are simplified block diagrams illustrating in a rear view, a side view, and a top view, respectively, a fairing system for aft-end drag reduction on a vehicle with a box-shaped enclosure according to a preferred embodiment of the invention with the fairing system being in a deployed position;

FIGS. 3 to 6 are simplified block diagrams illustrating in a rear view, a side view, and a top view, respectively, the fairing system for aft-end drag reduction on a vehicle with a box-shaped enclosure according to the preferred embodiment of the invention with the fairing system being in a collapsed position;

FIGS. 7 to 9 are simplified block diagrams illustrating in bottom views a deployed position, an intermediate position, and a collapsed position, respectively, of the second portion of the fairing system for aft-end drag reduction on a vehicle with a box-shaped enclosure according to the preferred embodiment of the invention;

FIG. 10 is a simplified block diagram illustrating in a bottom view an implementation with intermediate support booms of the second portion of the fairing system for aft-end drag reduction on a vehicle with a box-shaped enclosure according to the preferred embodiment of the invention;

FIG. 11a is a simplified block diagram illustrating in a bottom view an implementation with an inflatable skin and tethers of the second portion of the fairing system for aft-end drag reduction on a vehicle with a box-shaped enclosure according to the preferred embodiment of the invention;

FIG. 11b is a simplified block diagram illustrating in a bottom view an implementation with an inflatable double skin and tethers of the second portion of the fairing system for aft-end drag reduction on a vehicle with a box-shaped enclosure according to the preferred embodiment of the invention;

FIG. 12 is a simplified block diagram illustrating control circuitry of the fairing system for aft-end drag reduction on a vehicle with a box-shaped enclosure according to the preferred embodiment of the invention;

FIGS. 13 and 14 are simplified block diagrams illustrating in a rear perspective view and a top view, respectively, a fairing system for aft-end drag reduction on a vehicle with a box-shaped enclosure according to another preferred embodiment of the invention with the fairing system being in a retracted position;

FIGS. 15 to 18 are simplified block diagrams illustrating in a rear perspective view, a rear view, a side view, and a top view, respectively, the fairing system for aft-end drag reduction on a vehicle with a box-shaped enclosure according to the other preferred embodiment of the invention with the fairing system being in a deployed position;

FIGS. 19 and 20 are simplified block diagrams illustrating in a side perspective view and a top view, respectively, the fairing system for aft-end drag reduction on a vehicle with a box-shaped enclosure according to the other preferred embodiment of the invention with the fairing system being in a deployed position;

FIGS. 21 to 24 are simplified block diagrams illustrating in top views the deployment of the fairing system for aft-end drag reduction on a vehicle with a box-shaped enclosure according to the other preferred embodiment of the invention;

FIG. 25 is a simplified block diagram illustrating in top view adjustment of the angle of the wing-shaped body of the fairing system for aft-end drag reduction on a vehicle with a box-shaped enclosure according to the other preferred embodiment of the invention;

FIGS. 26 to 28 are simplified block diagrams illustrating in rear perspective views, and a top view employment of a connecting structure with the fairing system for aft-end drag reduction on a vehicle with a box-shaped enclosure according to the other preferred embodiment of the invention;

FIGS. 29 to 32 are simplified block diagrams illustrating in a rear perspective view, a rear view, a side view, and a top view, respectively, another fairing system for aft-end drag reduction on a vehicle with a box-shaped enclosure described herein with the fairing system being in a deployed position;

FIGS. 33 and 34 are simplified block diagrams illustrating in a rear view and a top view, respectively, the other fairing system described herein with the fairing system being in a retracted position;

FIGS. 35 to 37 are simplified block diagrams illustrating in cross-sectional top views actuation of the wing shaped body of the other fairing system described herein;

FIG. 38 is a simplified block diagram illustrating in a detailed rear view a quick lock/release mechanism of the other fairing system described herein;

FIG. 39 is a simplified block diagram illustrating in a top view the other fairing system described herein with the doors of the enclosure opened; and,

FIGS. 40 to 42 are simplified block diagrams illustrating in detailed top views mounting of the wing shaped body of the other fairing system described herein.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of embodiments hereinbelow is with reference to a fairing system for aft-end drag reduction on tractor-trailers, it will become evident to those skilled in the art that the embodiments of the invention are not limited thereto, but are also adaptable for other types of vehicles having a box-shaped enclosure such as, for example, box trucks, double trailer trucks, cube vans, or buses.

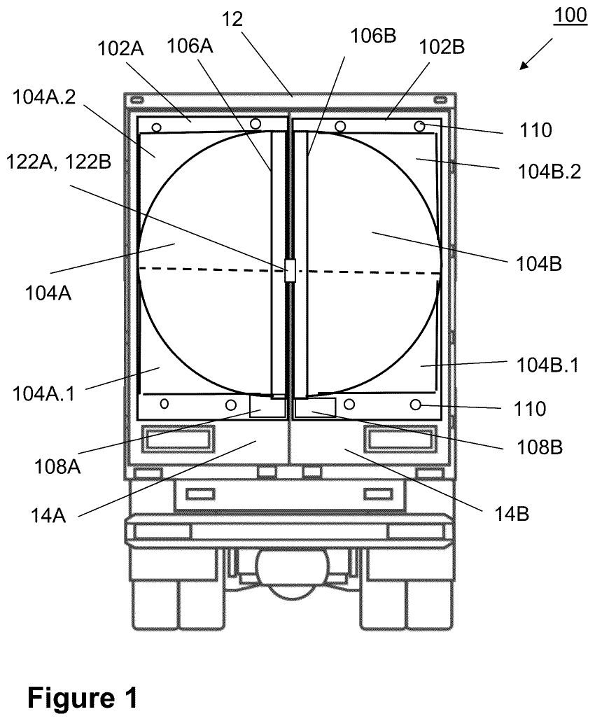

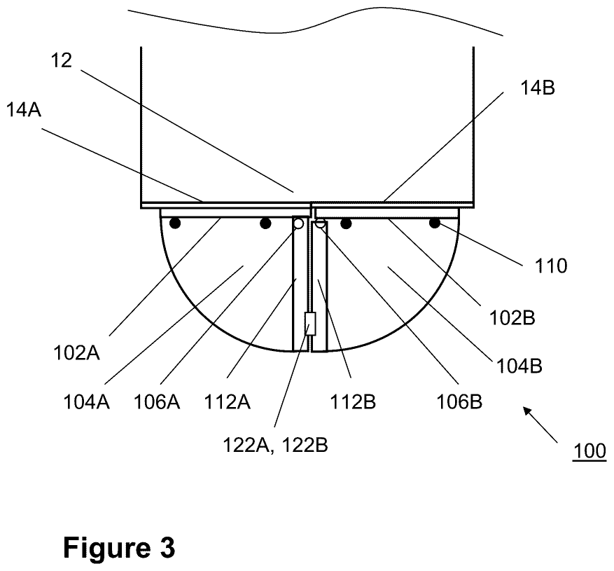

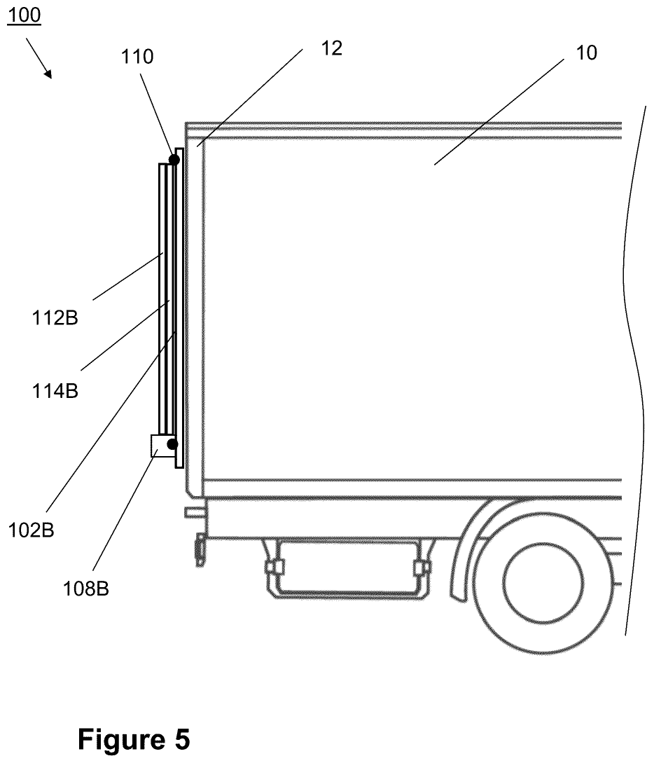

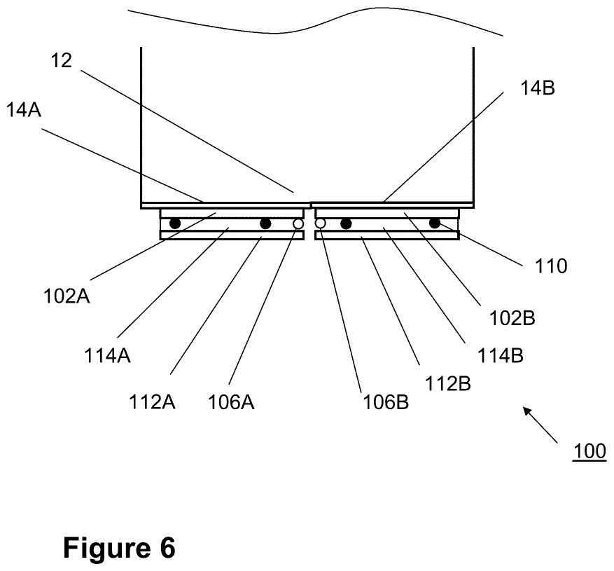

Referring to FIGS. 1 to 12, a fairing system for aft-end drag reduction on a vehicle with a box-shaped enclosure 100 according to a preferred embodiment of the invention is provided. The fairing system 100 comprises a substantially flat base adapted for being mounted to an aft-end 12 of the vehicle 10. Preferably, the base comprises a first portion 102A and a second portion 102B adapted for being mounted to a respective left hand side door 14A and right hand side door 14B of the vehicle 10. For example, the base portions 102A, 102B are of rectangular shape and sized for covering at least a portion of the respective door 14A, 14B and enabling mounting of the same in proximity of edges and/or corners of the door for substantially rigid support. Preferably, the base portions 102A, 102B are sized to be compatible with different sizes of vehicles for enabling easy retro-fitting of existing vehicles 10. For example, the base portions 102A, 102B may be sized to substantially cover the respective door 14A, 14B, as illustrated in FIGS. 1, 2, 4, and 5, or, alternatively, may be sized to cover only a portion of the respective door 14A, 14B starting in proximity of a top end of the respective door 14A, 14B and ending a distance from a bottom end of the respective door 14A, 14B such as, for example, one third or half the height of the respective door 14A, 14B.

Alternatively, the base is provided as a single unit for being mounted to the aft-end of a vehicle 10 that is loaded/unloaded via the left-hand side and/or the right-hand side thereof.

The base portions 102A, 102B are made of a suitable material that is sufficiently light weight and rigid such as, for example, aluminum sheet material or composite sheet material such as carbon epoxy sheet material in a conventional manner. Preferably, the base portions 102A, 102B comprise bolts 110 mounted thereto for being placed through respective apertures disposed at respective locations in the doors 14A, 14B and secured thereto using, for example, screw nuts or quick release pins, thus enabling easy attachment to/removal from the doors 14A, 14B for easily switching the fairing system 100 between different vehicles 10. Alternatively, the base portions 102A, 102B comprise apertures disposed therein and are mounted to the doors 14A, 14B via bolts 110 placed therethrough.

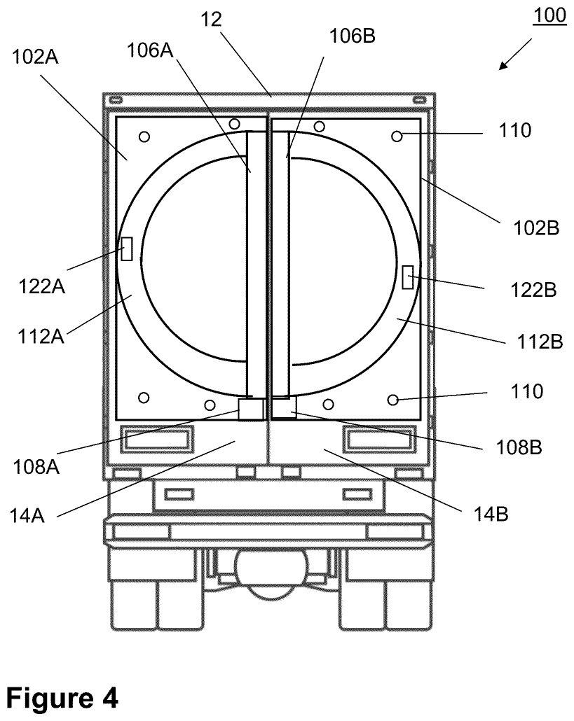

The fairing system 100 further comprises a streamlined body 104A, 104B with a first flexible skin 114A and a second flexible skin 114B forming a first portion 104A and a second portion 104B of an outer surface of the streamlined body extending rearwardly from the aft-end 12 when deployed, as illustrated in FIGS. 1 to 3, and being substantially flat when collapsed, as illustrated in FIGS. 4 to 6. Preferably, the streamlined body 104A, 104B is adapted to form a dome with approximately a first half of the dome extending rearwardly from the left hand side door 14A and approximately a second half of the dome extending rearwardly from the right hand side door 14B. For example, the dome forms a half-sphere, a half-ellipsoid, or a paraboloid. Alternatively, the streamlined body 104A, 104B is shaped to form a downstream portion of a drop-shaped body. Further preferably, the first flexible skin 114A and the second flexible skin 114B are shaped such that each portion of the outer surface of the streamlined body 104A, 104B comprises corner sections 104A.1, 104A.2 and 104B.1, 104B.2, respectively, where the outer surface smoothly transitions from substantially flat edges, oriented substantially parallel to the respective base portion 102A, 102B, to the shape of the respective streamlined body 104A, 104B.

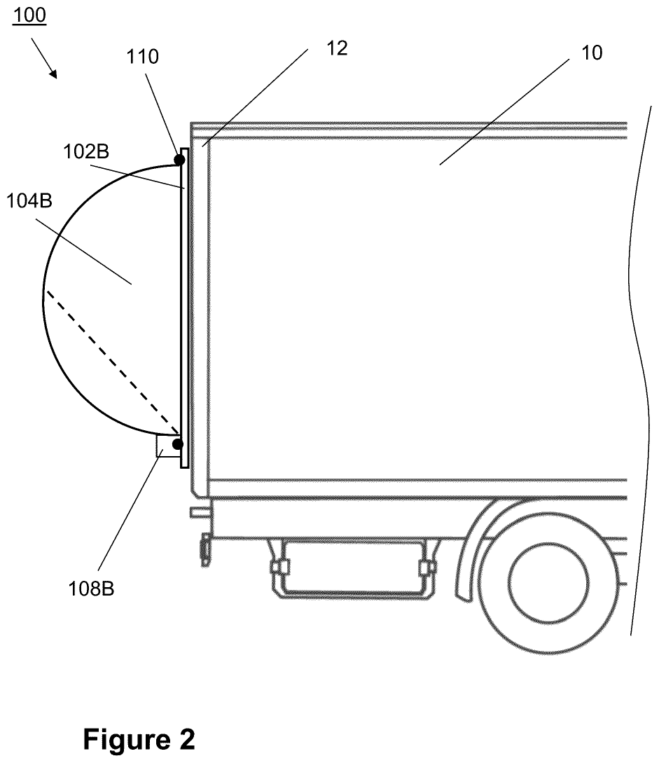

Optionally, a lower portion of the of the streamlined body 104A, 104B may be shaped differently than the upper portion such as, for example, substantially flat, as indicated by the dashed lines in FIGS. 1 and 2, or conical.

First curved support boom 112A and second curved support boom 112B each form an arc and are mounted to the first flexible skin 114A and the second flexible skin 114B, respectively. The ends of each of the support booms 112A and 112B are pivotally movable mounted to the respective base portion 102A, 102B such that the support booms 112A, 112B are oriented substantially perpendicular to the respective base portion 102A, 102B in the deployed position, as illustrated in FIGS. 1 to 3, and substantially parallel to the respective base portion 102A, 102B in the collapsed position, as illustrated in FIGS. 4 to 6.

The flexible skins 114A and 114B are, for example, made of a suitable plastic material such as Polymerized Vinyl Chloride (PVC) having a linear mass density between 500 and 2000 Denier in a conventional manner and are mounted to the respective base portion 102A, 102B using a commercially available adhesive. The support booms 112A and 112B may be made of a suitable material that is sufficiently light weight and rigid such as, for example, aluminum sheet material or a composite sheet material such as carbon epoxy material in a conventional manner. Alternatively, the support booms 112A and 112B made of tubing made of similar materials.

The ends of each of the support booms 112A and 112B are mounted to respective tubing 106A and 106B which in turn is pivotally movable mounted to the respective base portion 102A and 102B in a conventional manner. The tubing 106A and 106B is made of, for example, commercially available aluminum tubing having the respective support booms 112A and 112B mounted thereto in a conventional manner such as, for example, welding or adhering. Alternatively the support booms 112A and 112B and the respective tubing 106A and 106B are each made as a single unit having, for example, cylindrical shaft portions extending from the bottom portion for pivotally mounting the same to the respective base portion 102A and 102B.

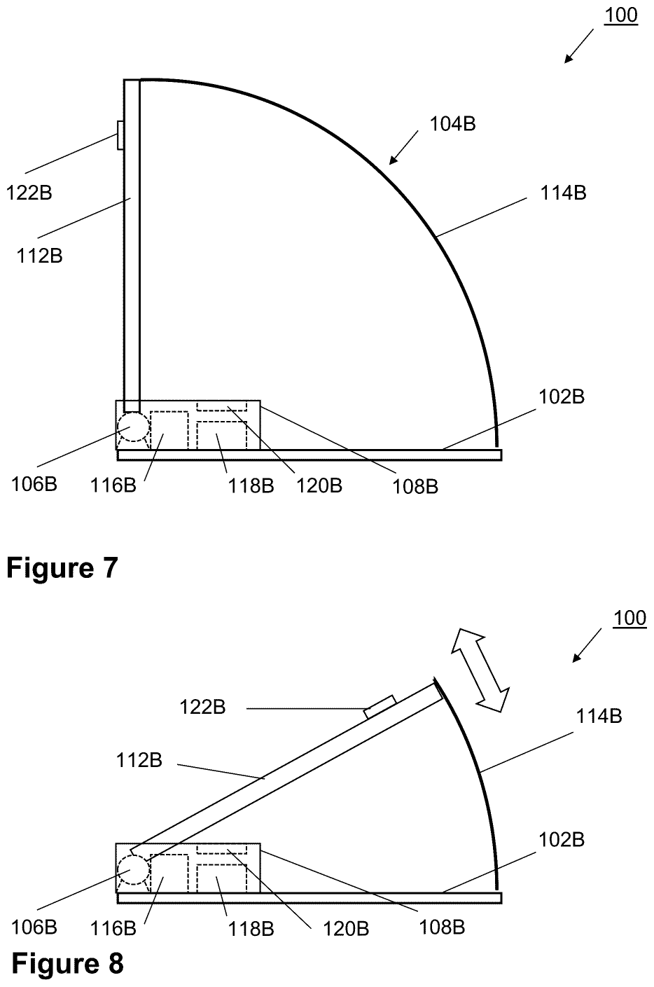

Referring to FIGS. 7 to 9, each of the tubing 106A and 106B is connected to a respective drive 116A and 116B such as, for example, a commercially available electric step motor, via a commercially available gear mechanism. It is noted that in FIGS. 7 to 9 only the second portion of the fairing system 100 is illustrated for simplicity since both portions are substantially the same and are operated in a substantially same manner. The drives 116A and 116B are powered by a power source such as, for example, a rechargeable battery 118A and 118B. The operation of the drives 116A and 116B is controlled by a respective control processor 120A and 120B such as, for example, a commercially available Field-Programmable Gate Arrays (FPGA), as will be described in more detail hereinbelow. The drives 116A and 116B, the batteries 118A and 118B, and the processors 120A and 120B are disposed in respective protective housings 108A and 108B mounted to the respective base portions 102A and 102B. Preferably, the protective housing 108A and 108B is substantially waterproof. Alternatively, the drives 116A and 116B are electric drives powered by the electric system of the vehicle 10 or pneumatic drives powered by the compressed air system of the vehicle 10.

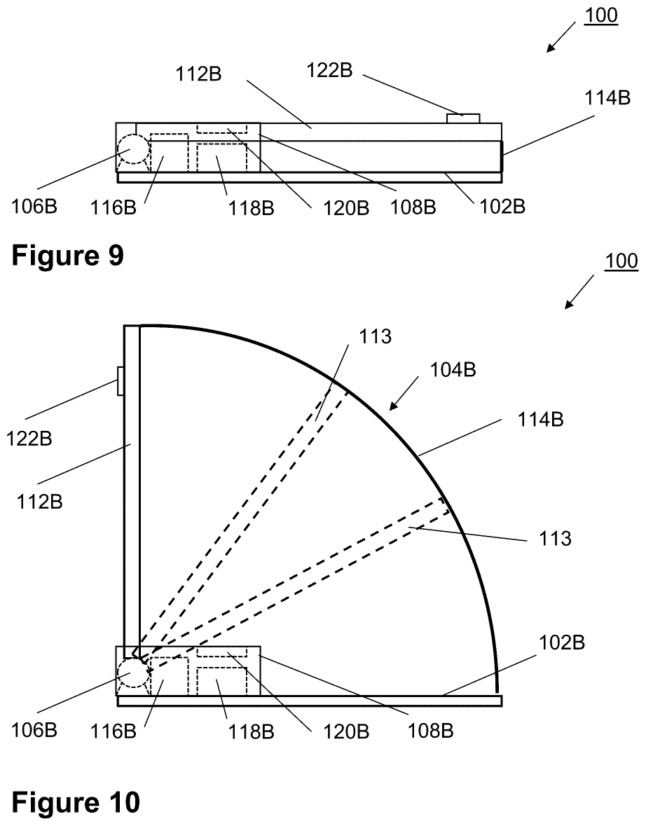

In operation, the drives 116A and 116B pivotally move the respective support booms 112A and 112B, as indicated by the block arrow in FIG. 8, between the deployed position, as illustrated in FIG. 7, and the collapsed position, as illustrated in FIG. 9. In particular, for deploying the streamlined body portions 104A and 104B, the support booms 112A and 112B are moved from the collapsed position illustrated in FIG. 9 via an intermediate position illustrated in FIG. 8 to the deployed position illustrated in FIG. 7, thus pulling the flexible skins 114A and 114B from the collapsed position to the deployed position with the flexible skins 114A and 114B forming the first portion 104A and the second portion 104B of the outer surface of the streamlined body. To collapse the streamlined body portions 104A and 104B, the same process is performed in reverse.

Further preferably, a securing mechanism 122A, 122B for securing the support booms 112A and 112B to each other in the deployed position is provided. The securing mechanism 122A, 122B comprises, for example, a commercially available electromagnet disposed on one of the support booms 112A and 112B and a ferromagnetic element disposed at an opposite location on the other of the support booms 112A and 112B. The securing mechanism 122A, 122B is, preferably, placed in proximity of the apex of the support booms 112A and 112B. The electromagnet is connected to the respective control processor 120A, 120B to control operation thereof. Optionally, the securing mechanism 122A, 122B may comprise more than one electromagnet and respective ferromagnetic element.

Optionally, each of the streamlined body portions 104A and 104B comprises one or more curved intermediate support booms 113. The intermediate support booms 113 are mounted to the respective first and second flexible skins 114A and 114B and are pivotally movable mounted to the respective first and second base portions 102A and 102B. During deployment of the streamlined body portions 104A and 104B, the intermediate support booms 113 are pulled into position by the respective skins 114A and 114B which in turn are pulled by the respective support booms 112A and 112B. Provision of the intermediate support booms 113 stiffens the streamlined body portions 104A and 104B.

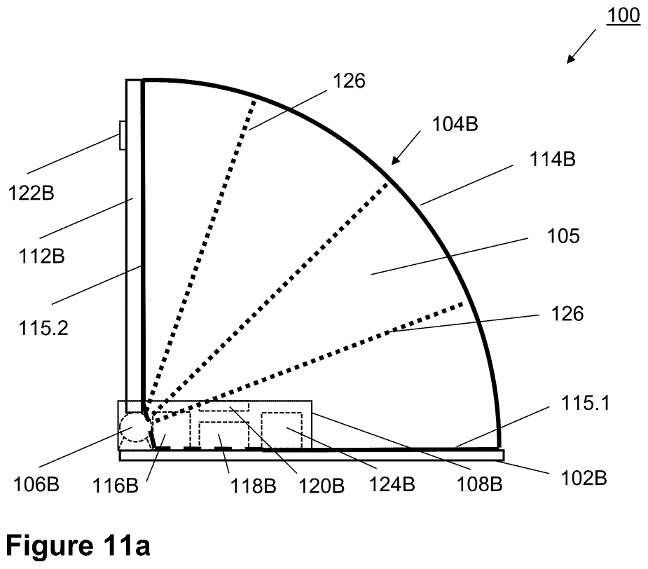

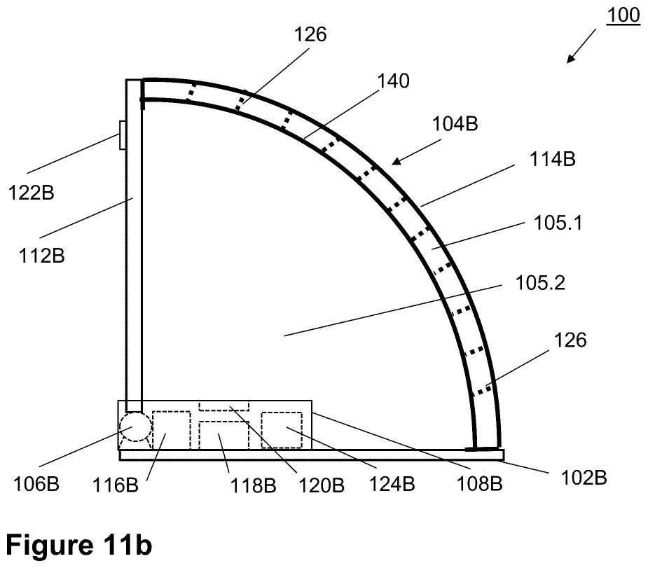

Alternatively, as illustrated in FIG. 11a, each of the first and the second flexible skin 114A and 114B comprises: a substantially flat bottom portion 115.1 mounted to the respective first and second base portion 102A and 102B; a curved top portion 114A and 114B forming the outer surface of the respective first and second half of the dome 104A and 104B; and, a substantially flat wall portion 115.2 connected to the respective bottom portion 115.1 and top portion 114A and 114B such that the wall portion 115.2 is oriented substantially perpendicular to the bottom portion 115.1 when deployed and wherein each of the first and the second flexible skin 114A and 114B forms a substantially airtight enclosure 105. Each of the airtight enclosures 105 is connected to, for example, a respective electric air compressor 124A, 124B for providing compressed air thereto. Alternatively, the compressed air is provided by the compressed air system of the vehicle 10.

Optionally, each of the a first and the second flexible skin 114A and 114B comprises at least a tether 126 mounted thereto for providing rigidity to the respective first and second half of the dome 104A and 104B. The tethers 126 are, for example, placed such that they start at the bottom center of the wall portion 115.2 and extend radially outwardly. Alternatively, the tethers 126 are provided as numerous drop-stitch threads made of, for example, polyester, similar to inflatable stand-up paddle boards.

Further alternatively, each of the streamlined body portions 104A, 104B is provided in a dual skin manner, as illustrated in FIG. 11b for the second half of the dome 104B. Each of the first and the second flexible skin 114A and 114B comprises a respective inner skin 140 oriented substantially parallel thereto at a predetermined distance. Each of the first and the second flexible skin 114A and 114B together with the respective inner skin 140 is adapted to form a substantially airtight enclosure 105.1 which is connected to, for example, a respective electric air compressor 124A, 124B for providing compressed air thereto. Alternatively, the compressed air is provided by the compressed air system of the vehicle 10. When deployed, each of the dual skins 114A, 114B in concert with the respective inner skin 140 forms a shell surrounding inner volume 105.2 which is not pressurized.

Optionally, tethers 126 are disposed inside the enclosure 105.1 connecting each of the a first and the second flexible skin 114A and 114B with the respective inner skin 140 for providing rigidity to the respective first and second half of the dome 104A and 104B. Alternatively, the tethers 126 are provided as numerous drop-stitch threads made of, for example, polyester, similar to inflatable stand-up paddle boards.

Further optionally, each of the first and the second flexible skin 114A and 114B comprises means for preventing ice-buildup on the outer surface of the dome 104A, 104B such as, for example, respective electrical heating elements 134A and 134B embedded therein.

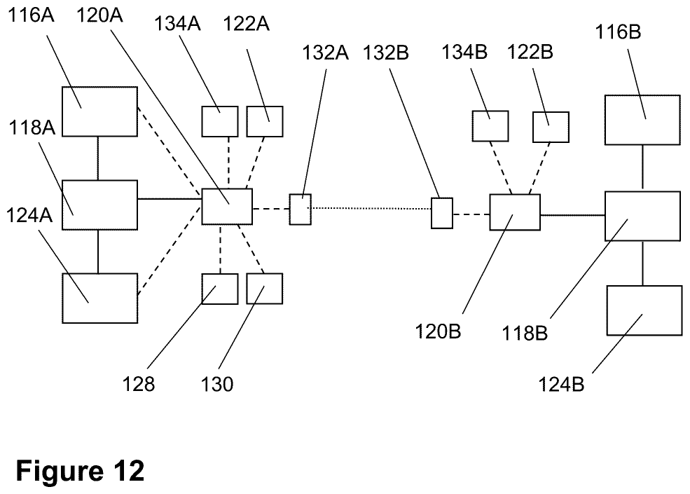

FIG. 12 illustrates a preferred control circuitry of the fairing system 100. Processors 120A and 120B are connected to; the respective drives 116A and 116B; the respective batteries 118A and 118B; the respective securing mechanisms 122A and 122B; and respective wireless communication devices 132A and 132B. The wireless communication devices 132A and 132B enable data and command exchange between the processors 120A and 120B, as well as synchronization of the actions provided by the processors 120A and 120B and the respective components connected thereto. One of the processors, here processor 120A, is connected to a speed sensor 128 such as, for example, a commercially available pitot probe based speed sensor. Alternatively, the processor may receive data indicative of a speed of the vehicle 10 from the control system thereof.

Further preferably, the fairing system 100 comprises a temperature sensor 130 connected to one of the processors, here processor 120A. The temperature sensor 130 is adapted for sensing an ambient temperature and for providing temperature data in dependence thereupon to the processor 120A

Optionally, the processors 120A and 120B are connected to the respective electric air compressors 124A and 124B, and, further optionally, to the respective electrical heating elements 134A and 134B, depending on design preferences.

Further optionally, the fairing system 100 comprises a Human Machine Interface (HMI) in communication with the processors 120A and 120B for being placed in the driver cabin of the vehicle 10. The HMI such as, for example, a touch screen, displays status data of the fairing system such as, for example, the dome being deployed or collapsed, or any malfunction thereof. Preferably, in case of a malfunction a warning message is displayed informing the driver of a malfunction and the type of the malfunction. Further preferably, in case of a malfunction the driver is enabled to overwrite the automatic control of the fairing systems and to collapse the dome 104A, 104B.

In operation, the processor 120A receives data from the speed sensor 128 indicative of a speed of the vehicle 10, for example, a speed that is above a predetermined first threshold speed of 45 mph. The processor 120A then provides power to the drive 116A and prompts the processor 120B via the wireless communication 132A, 132B to provide power to the drive 116B. The drives 116A and 116B then move the first and second support boom 112A and 112B into the deployed position. Once the support booms 112A and 112B are in the deployed position, the power provision to the drives 116A and 116B is stopped, and the processor 120A provides power to the securing mechanism 122A and prompts the processor 120B via the wireless communication 132A, 132B to provide power to the securing mechanism 122B.

Optionally, the processor 120A also provides power to the air compressor 124A and prompts the processor 120B via the wireless communication 132A, 132B to provide power to the air compressor 124B.

At this stage, the dome 104A and 104B is fully deployed for reducing aft-end drag reduction on the vehicle 10.

When the processor 120A receives data from the speed sensor 128 indicative of the speed of the vehicle 10 being below a, preferably, second predetermined threshold speed of, for example, 35 mph, the processor 120A stops power provision to the securing mechanism 122A and prompts the processor 120B via the wireless communication 132A, 132B to stop the power provision to the securing mechanism 122B. The processor 120A then provides power to the drive 116A and prompts the processor 120B via the wireless communication 132A, 132B to provide power to the drive 116B. The drives 116A and 116B then move the first and second support boom 112A and 112B into the collapsed position.

Optionally, the dome 104A and 104B is collapsed when the speed of the vehicle 10 is below the predetermined second threshold speed for a predetermined period of time such as, for example, 5 minutes, in order to prevent too frequent deployment/collapsing of the dome 104A and 104B.

Further optionally, the fairing system 100 comprises a temperature sensor 130 connected to the processor 120A. The temperature sensor senses an ambient temperature and provides temperature data in dependence thereupon to the processor 120A. When the ambient temperature is below a predetermined threshold temperature such as, for example, −5 C, the processor 120A prevents the support booms 112A and 112B from being moved into the deployed position. Furthermore, in case the dome 104A, 104B is deployed the processor 120A provides power to the drive 116A and prompts the processor 120B via the wireless communication 132A, 132B to provide power to the drive 116B to move the first and second support boom 112A and 112B into the collapsed position when the ambient temperature is below the predetermined threshold temperature.

The threshold temperature is determined as the temperature below which there is a risk of ice buildup on the dome. Thus, the above modes of operation provide an important safety feature by preventing deployment or initiating collapsing of the dome 104A, 104B when the ambient temperature is below the threshold temperature and, consequently, preventing ice from falling off the dome 104A, 104B and hitting vehicles driving behind the vehicle 10.

Further optionally, the first and second support boom 112A and 112B are moved into the collapsed position when the ambient temperature is below the predetermined threshold temperature for a predetermined period of time such as, for example, 5 minutes.

Alternatively, the fairing system 100 comprises means for preventing ice-buildup 134A and 134B connected to the respective processors 120A and 120B, which are activated when the ambient temperature is below the predetermined threshold temperature.

Optionally, the means for preventing ice-buildup 134A and 134B is activated when the ambient temperature is below the predetermined threshold temperature for a predetermined period of time such as, for example, 5 minutes.

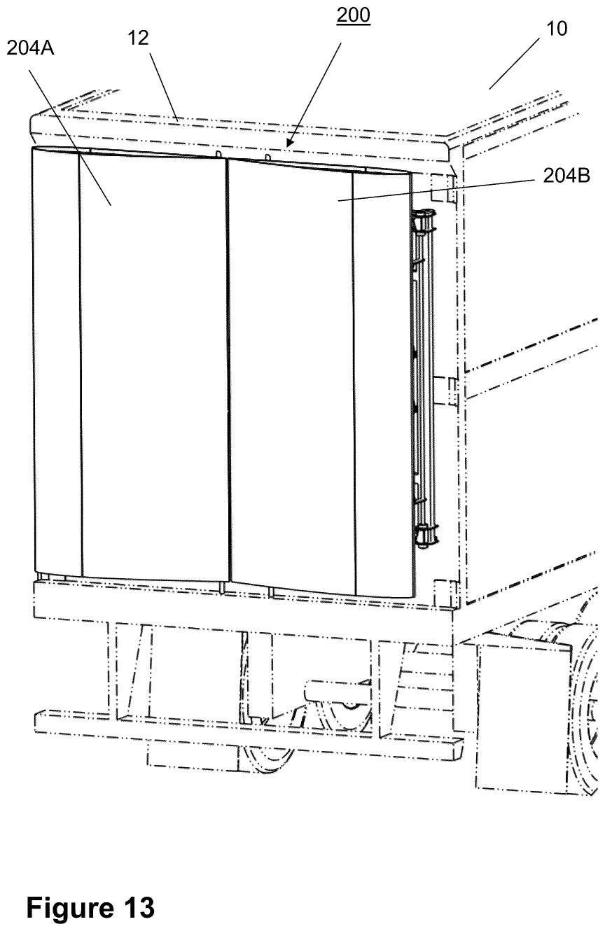

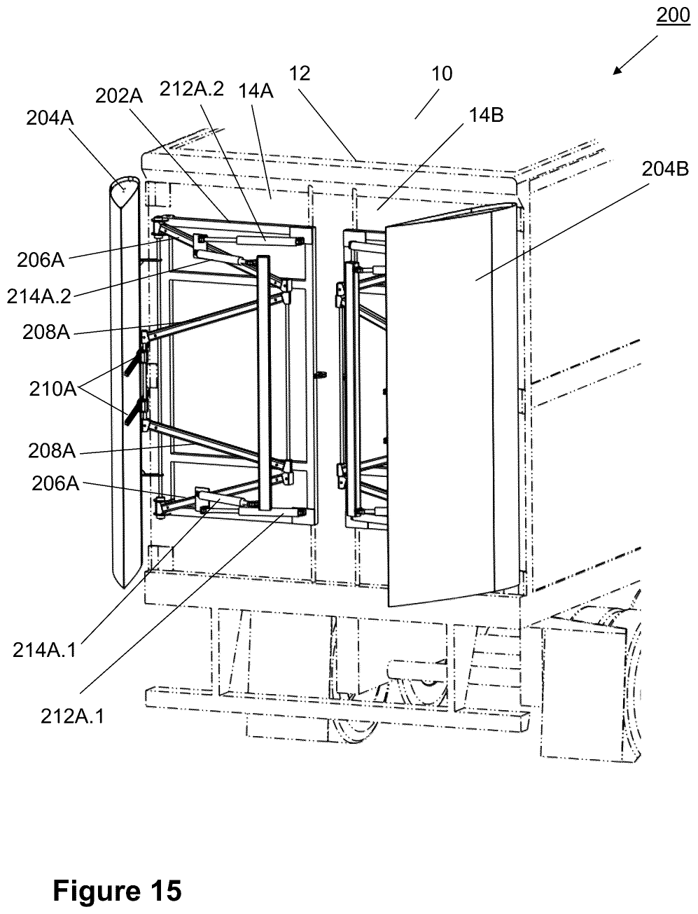

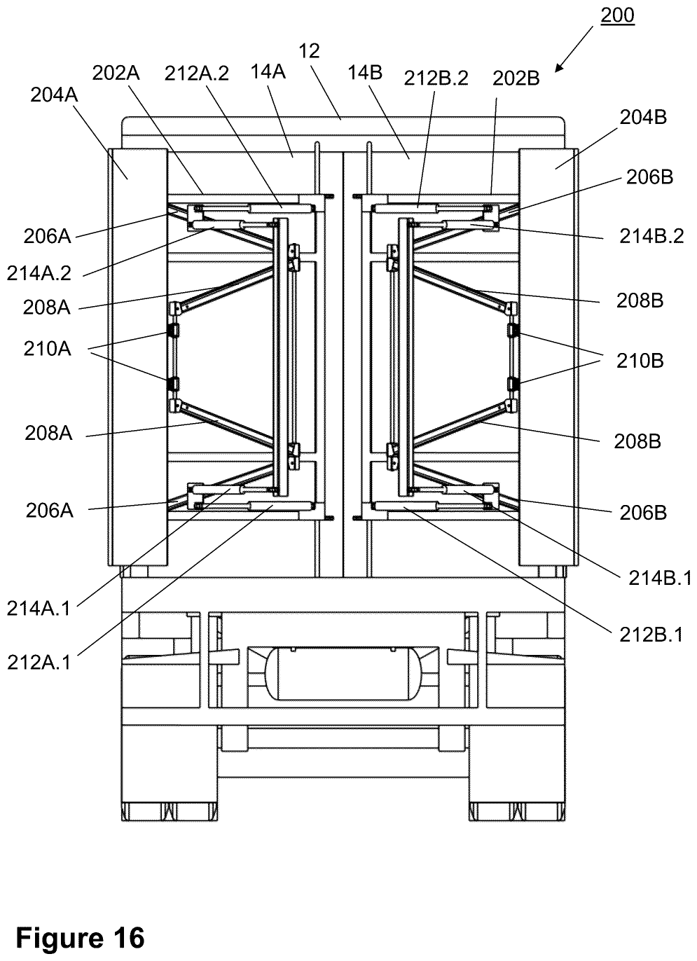

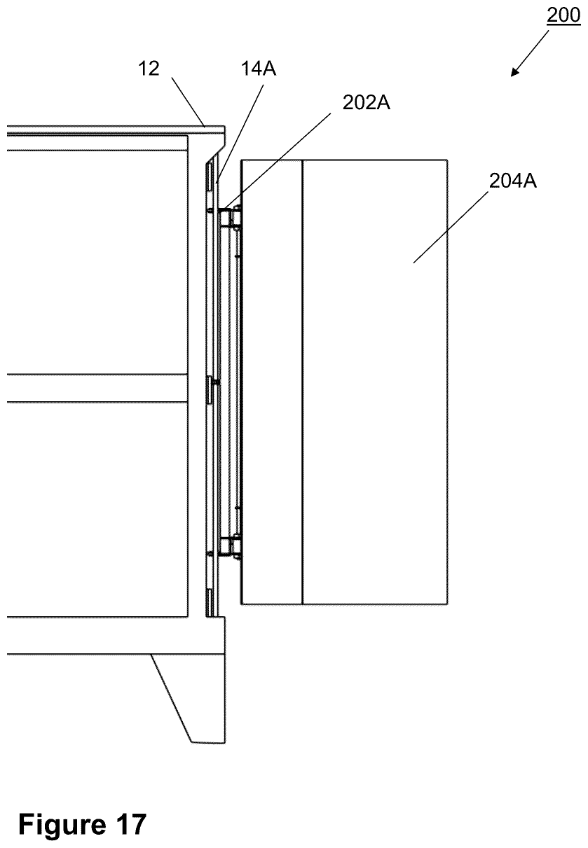

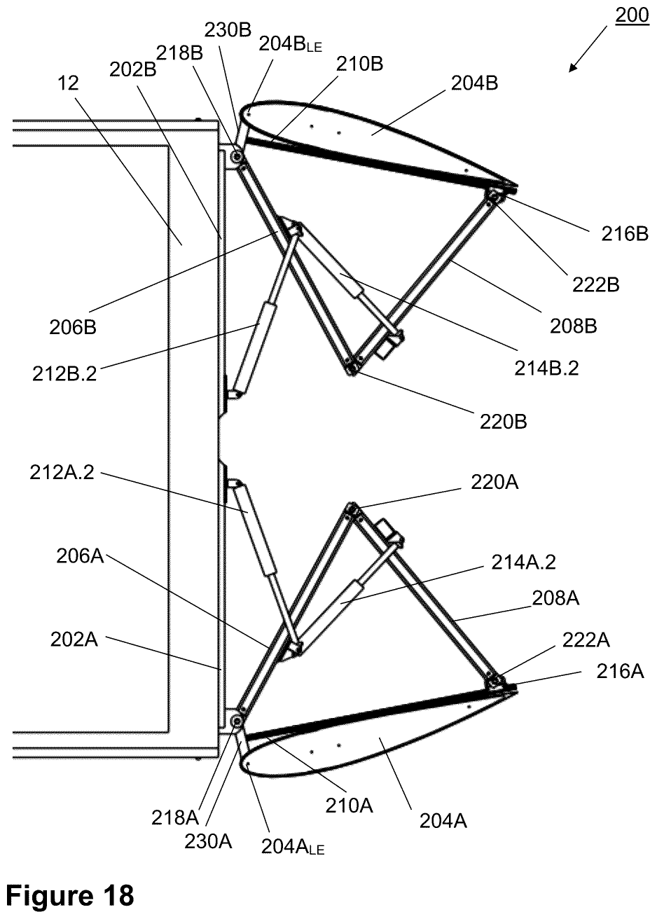

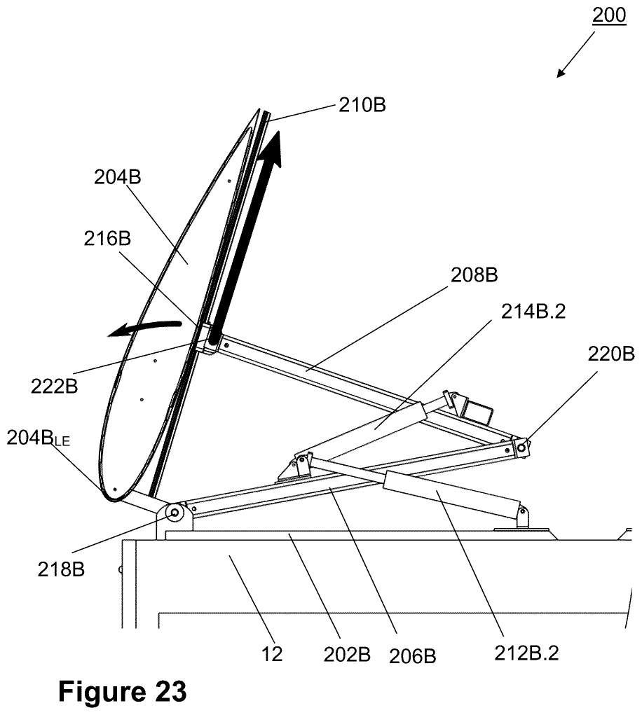

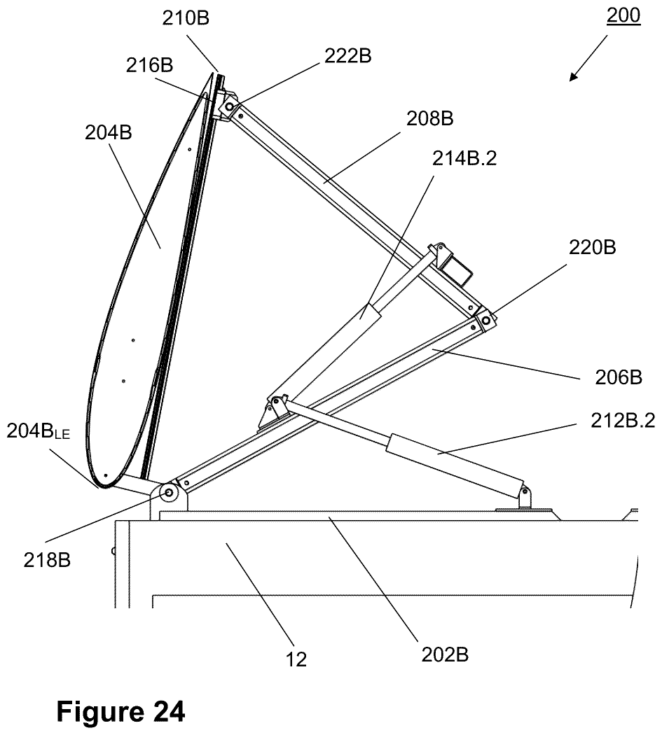

Referring to FIGS. 13 to 28 a fairing system for aft-end drag reduction on a vehicle with a box-shaped enclosure 200 according to another preferred embodiment of the invention is provided. The fairing system 200 comprises a substantially flat base adapted for being mounted to an aft-end 12 of the vehicle 10. Preferably, the base comprises a first portion 202A and a second portion 202B adapted for being mounted to a respective left hand side door 14A and right hand side door 14B of the vehicle 10. For example, the base portions 202A, 202B are of rectangular shape and sized for covering at least a portion of the respective door 14A, 14B and enabling mounting of the same in proximity of edges and/or corners of the door for substantially rigid support. Preferably, the base portions 202A, 202B are sized to be compatible with different sizes of vehicles for enabling easy retro-fitting of existing vehicles 10. For example, the base portions 202A, 202B may be sized to cover a substantial portion of the respective door 14A, 14B, as illustrated in FIGS. 15 and 16 or, alternatively, may be sized to cover only a portion of the respective door 14A, 14B, for example, starting in proximity of a top end of the respective door 14A, 14B and ending a distance from a bottom end of the respective door 14A, 14B such as, for example, one third or half the height of the respective door 14A, 14B.

Alternatively, the base is provided as a single unit for being mounted to the aft-end of a vehicle 10 that is loaded/unloaded via the left-hand side and/or the right-hand side thereof.

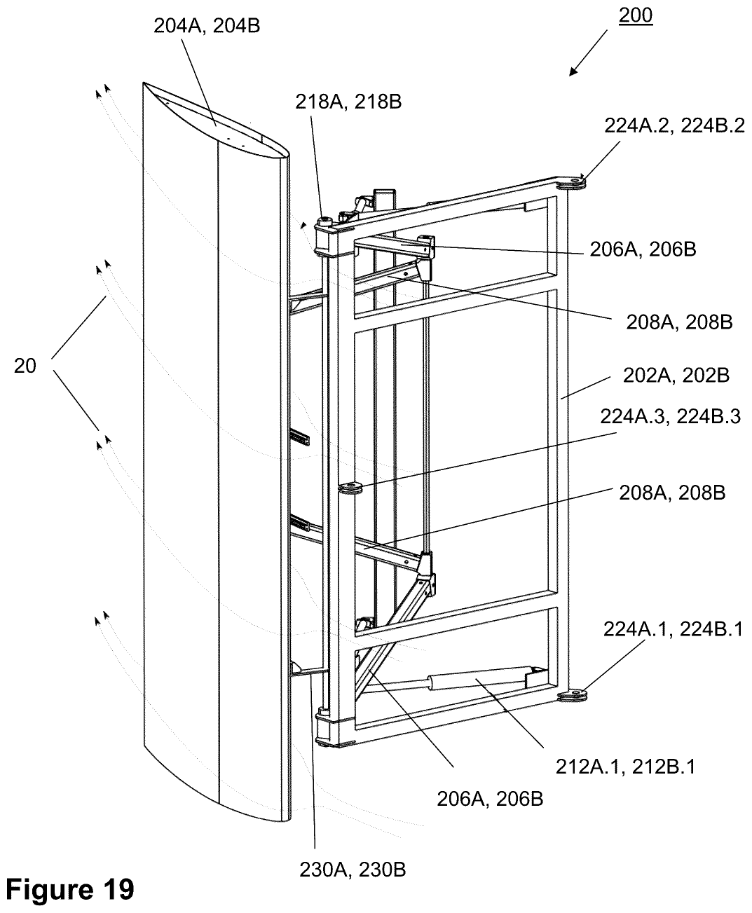

The base portions 202A, 202B are made, for example, as a rectangular frame structure using commercially available profiles or tubing having a circular, square, or rectangular cross section and are made of a suitable material that is sufficiently light weight and rigid such as, for example, aluminum or composite material such as carbon composite material in a conventional manner. Alternatively, the base portions 202A, 202B are provided as flat sheets made of, for example, aluminum or composite sheet material. Preferably, the base portions 202A, 202B each comprise mounting elements 224A.1, 224A.2, 224A.3, 224B.1, 224B.2, 224B.3 mounted thereto, as illustrated in FIG. 19, for being mated with respective mounting elements disposed on the doors 14A, 14B using, for example, bolts accommodated in respective bores disposed in the mounting elements, thus enabling easy attachment to/removal from the doors 14A, 14B for easily switching the fairing system 200 between different vehicles 10. It is noted that in FIG. 19 only the right hand side portion of the fairing system 200 is shown for simplicity.

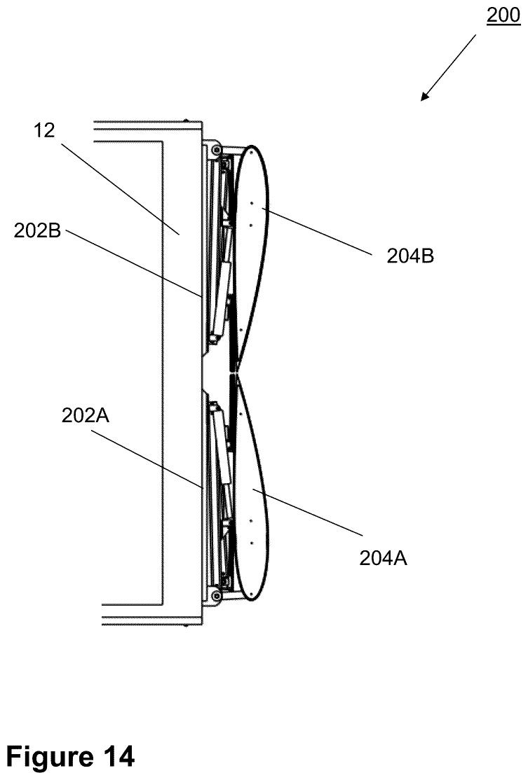

The fairing system 200 further comprises a first and a second wing-shaped body 204A, 204B. A leading edge portion 204ALE, 204BLE of each of the first and the second wing-shaped body 204A, 204B is pivotally movable mounted to the respective base 204A, 204B at pivot 218A, 218B located in proximity to a respective left hand side edge and right hand side edge of the vehicle 10 such that each of the first and the second wing-shaped body 204A, 204B is movable between a retracted position with the first and the second wing-shaped body 204A, 204B being oriented substantially parallel to the aft-end 12 of the vehicle 10, as illustrated in FIGS. 13 and 14 and a deployed position with the first and the second wing-shaped body 204A, 204B being oriented rearwardly and inwardly, as illustrated in FIGS. 15 to 18.

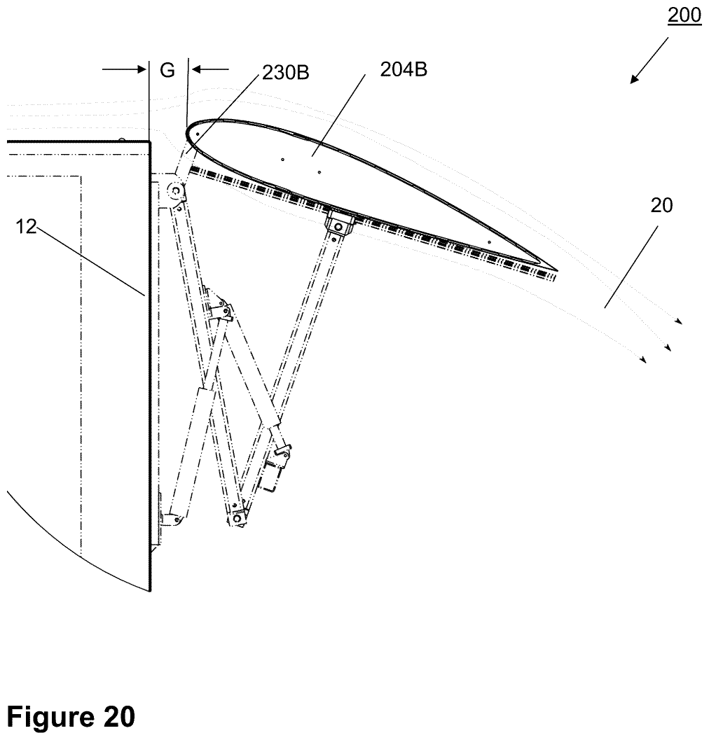

The leading edge portion 204ALE, 204BLE of each of the first and the second wing-shaped body 204A, 204B is connected to the respective pivot 218A, 218B via element 230A, 230B in order for the leading edge portion 204ALE, 204BLE being placed in the deployed position such that there is a predetermined gap G between the same and the aft-end 12 of the vehicle 10 for enabling an airflow therethrough and along an inside surface of each of the first and the second wing-shaped body 204A, 204B, as indicated by the streamlines 20 in FIGS. 19 and 20. Directing a portion of the airflow into the inside space between the two wing-shaped bodies 204A, 204B and along an inside surface of each of the first and the second wing-shaped body 204A, 204B further reduces the wake generated at the aft-end 12 of the vehicle 10 and, consequently drag. It is noted that in FIG. 20 only the right hand side portion of the fairing system 200 is shown for simplicity.

The fairing system 200 further comprises a support structure mounted to each of the base portions 202A, 202B and each of the respective first and second wing-shaped body 204A, 204B. The support structure secures the first and the second wing-shaped body 204A, 204B to the respective base portion 202A, 202B and enables moving of the first and the second wing-shaped body 204A, 204B between the retracted position and the deployed position.

Referring to FIGS. 15, 16, 18, and 21 to 25, the support structure comprises, for example, a first support frame 206A, 206B which is pivotally movable mounted to the respective base portion 202A, 202B via pivot 218A, 218B at a first end thereof. A first end of second support frame 208A, 208B is pivotally movable mounted to the respective first support frame 206A, 206B via pivot 220A, 220B at an opposite second end thereof. A second opposite end of the second support frame 208A, 208B is pivotally movable, at pivot 222A, 222B, mounted to guiding element 216A, 216B which is linearly movable interfaced with respective guide rail 210A, 210B mounted to the respective first and second wing-shaped body 204A, 204B. Pivotal movement of the first support frame 206A, 206B about pivot 218A, 218B is actuated via linear actuators 212A.1, 212A.2, 212B.1, 212B.2 which are pivotally movable mounted to the respective base portion 202A, 202B and first support frame 206A, 206B. Pivotal movement of the second support frame 208A, 208B about pivot 220A, 220B, as well as the linear movement along the guide rail 210A, 210B is actuated via linear actuators 214A.1, 214A.2, 214B.1, 214B.2 which are pivotally movable mounted to the respective first support frame 206A, 206B and second support frame 208A, 208B. Alternatively, the guiding elements 216A, 216B and the guide rails 210A, 210B may be replaced by wheels pivotally movable mounted to the second support frames 208A, 208B and pulling mechanisms for pulling the wing-shaped bodies 204A, 204B towards the respective first support frames 206A, 206B such as, for example, spring loaded ropes.

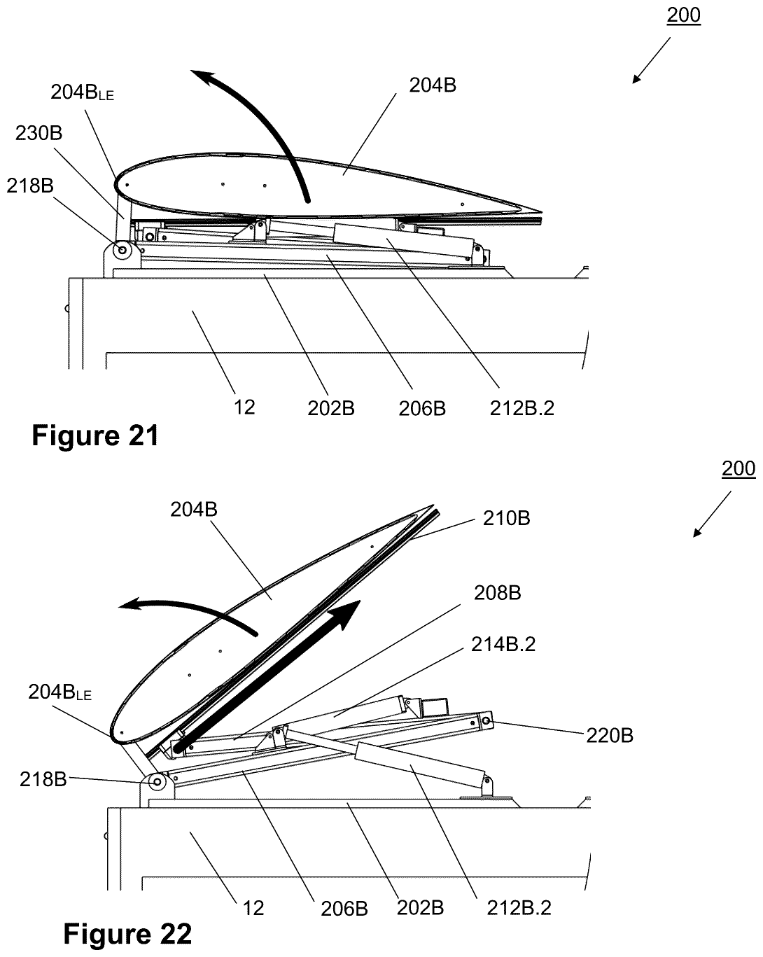

Using the linear actuators the wing-shaped bodies 204A, 204B are moved from the retracted position to the deployed position as indicated by the arrows in FIGS. 21 to 24. For retracting the wing-shaped bodies 204A, 204B the process is reversed.

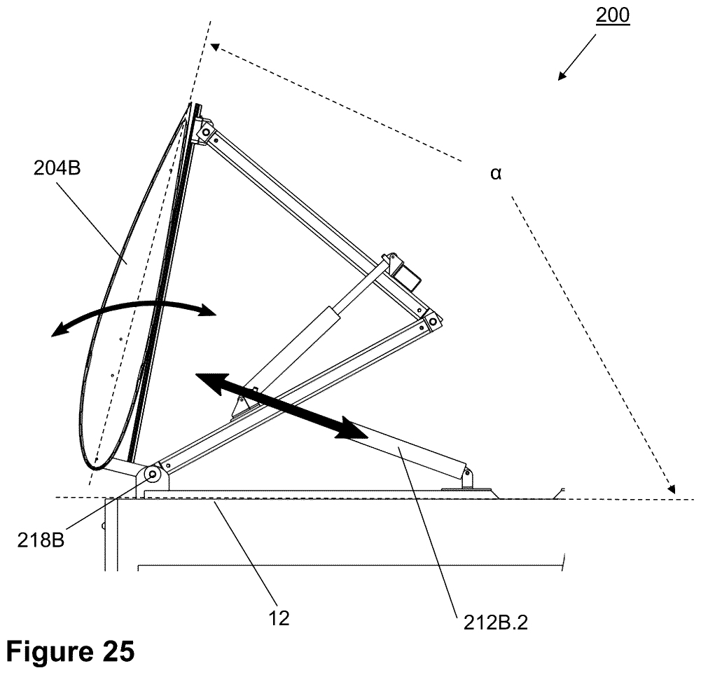

Optionally, the angle ∝ between the wing-shaped bodies 204A, 204B and the aft-end 12 of the vehicle 10 may be adjusted, for example, depending on the speed of the vehicle, using the linear actuators 212A.1, 212A.2, 212B.1, 212B.2, as illustrated in FIG. 25.

It is noted that in FIGS. 21 to 25 only the right hand side portion of the fairing system 200 is shown for simplicity.

The first and the second support frames 206A, 206B, 208A, 208B, the element 230A, 230B and the guide rail 210A, 210B may be made of a suitable material that is sufficiently light weight and rigid such as, for example, tubing having a circular, square, or rectangular cross-section and being made of aluminum or a composite material in a conventional manner. The linear actuators 212A.1, 212A.2, 212B.1, 212B.2, 214A.1, 214A.2, 214B.1, 214B.2 may be implemented using commercially available linear actuators such as, for example, “DC HOUSE 12 Inch 12″ High Speed 14 mm/s Linear Actuator Motor 1000N DC12V with Mounting Brackets” manufactured by ECO LLC, or “12V Waterproof (450 lbs./4 in.) Linear Actuator |IP68M/IP69K Protection for Industrial, Solar Usage|Brushed DC Electric Motor and Stainless-Steel Stroke Rod|Model PA-10-4-450-N-12 VDC” manufactured by PROGRESSIVE AUTOMATIONS.

The wing-shaped bodies 204A, 204B may be made of suitable material that is sufficiently light weight and rigid such as, for example, aluminum sheet material or composite sheet material in a conventional manner. Alternatively, the wing-shaped bodies 204A, 204B may be made as inflatable bodies with the hull being made of a flexible material such as Polymerized Vinyl Chloride (PVC) having a linear mass density between 500 and 2000 Denier in a conventional manner. Optionally, tethers such as, for example, numerous drop-stitch threads made of, for example, polyester, similar to inflatable stand-up paddle boards may be disposed inside the hull.

The fairing system 200 may be operated in a similar manner as the fairing system 100 using the control circuitry described hereinabove with reference to FIG. 12.

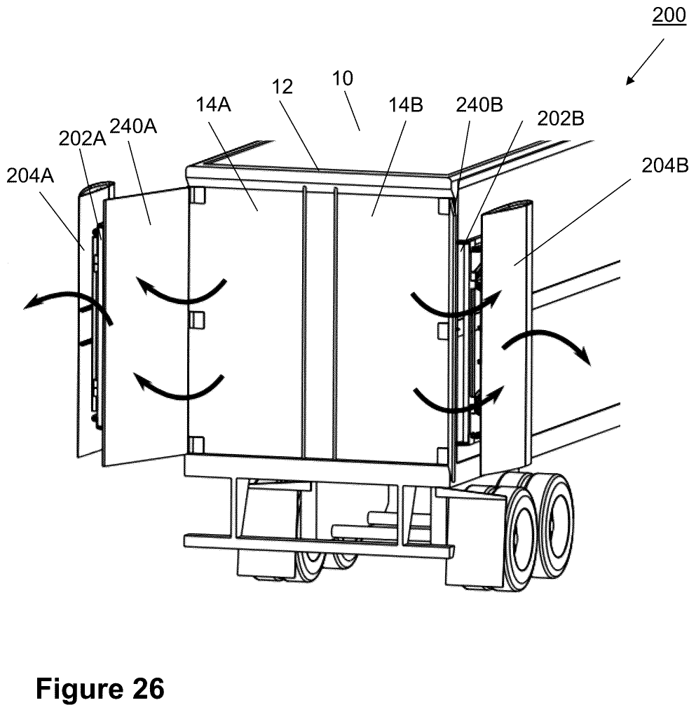

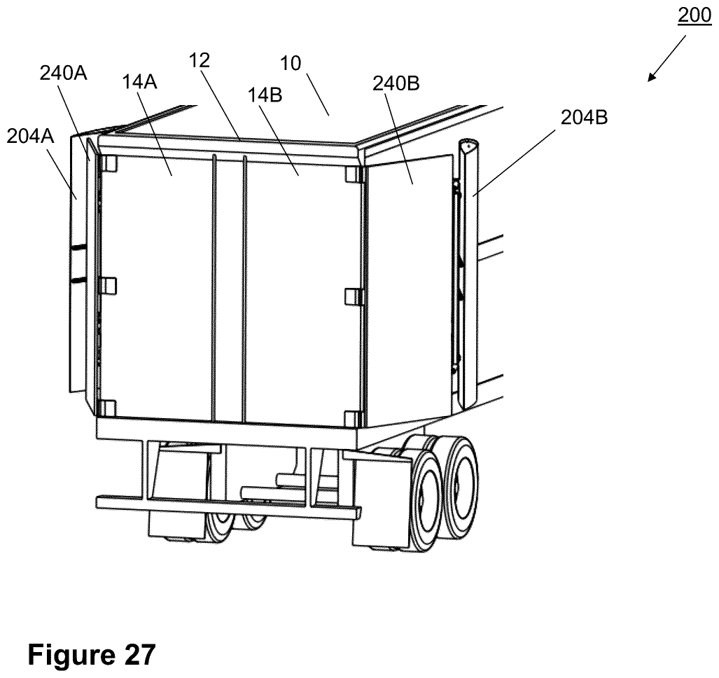

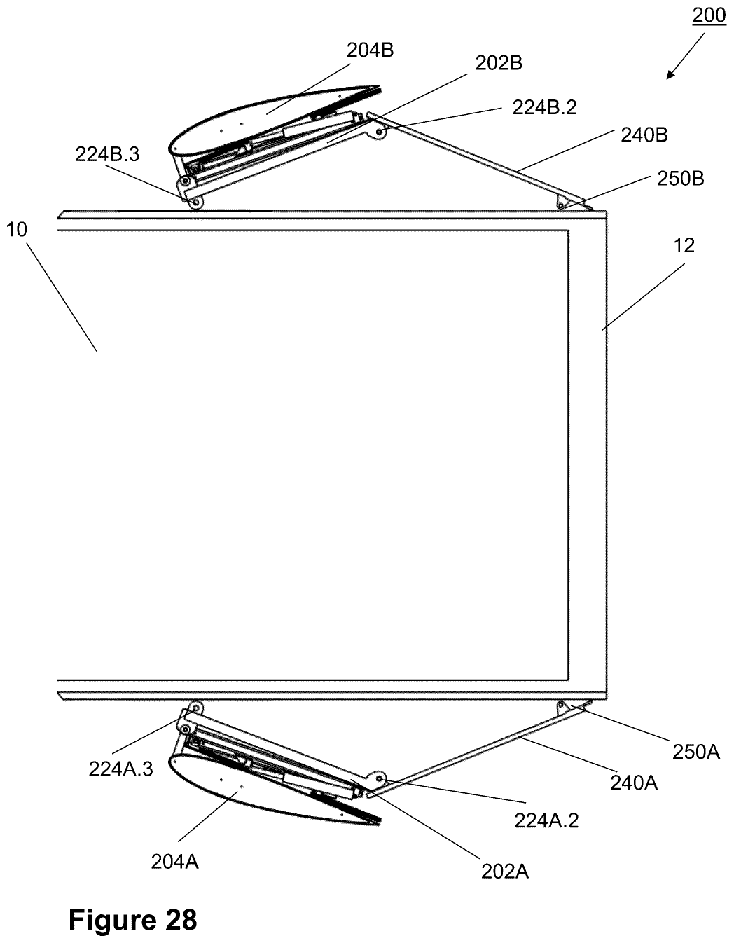

Referring to FIGS. 26 to 28, the fairing system 200 may be provided with an intermediate connecting structure 240A, 240B pivotally movable mounted to the aft-end 12 of the vehicle 10 at a first edge portion thereof. The mounting elements 224A.1, 224A.2, 224B.1, 224B.2 of the base portions 202A, 202B are pivotally movable mounted, via pivots 250A, 250B, to a second opposite edge portion of the respective connecting structure 240A, 240B. Provision of the connecting structure 240A, 240B enables the wing-shaped bodies 204A, 204B to be moved along the side of the box-shaped enclosure of the vehicle, as illustrated in FIGS. 27 and 28, thus facilitating backing-up of the vehicle 10 in confined spaces such as loading bays of warehouses.

The connecting structure 240A, 240B may be provided as a plate-like structure made of a suitable material that is sufficiently light weight and rigid such as, for example, aluminum sheet material or composite sheet material in a conventional manner or, alternatively, as a frame structure made of a suitable material that is sufficiently light weight and rigid such as, for example, tubing having a circular, square, or rectangular cross-section and being made of aluminum or a composite material in a conventional manner.

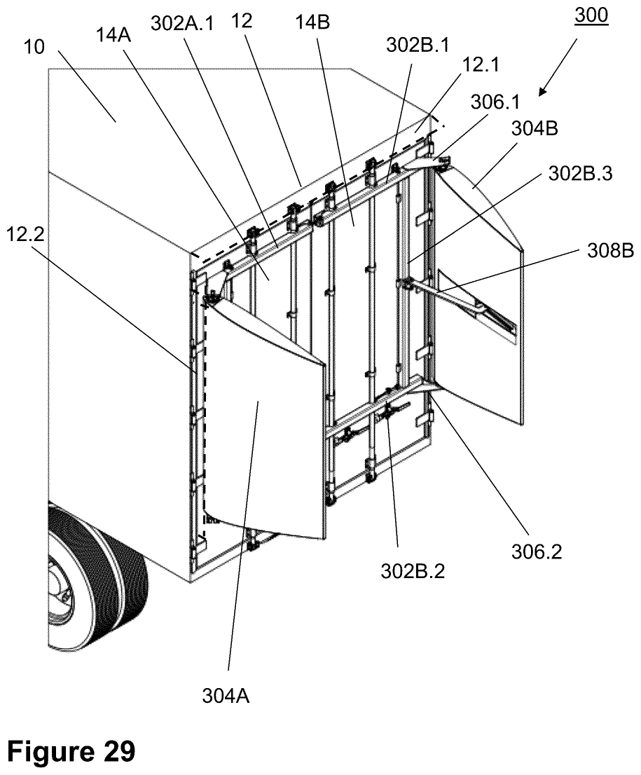

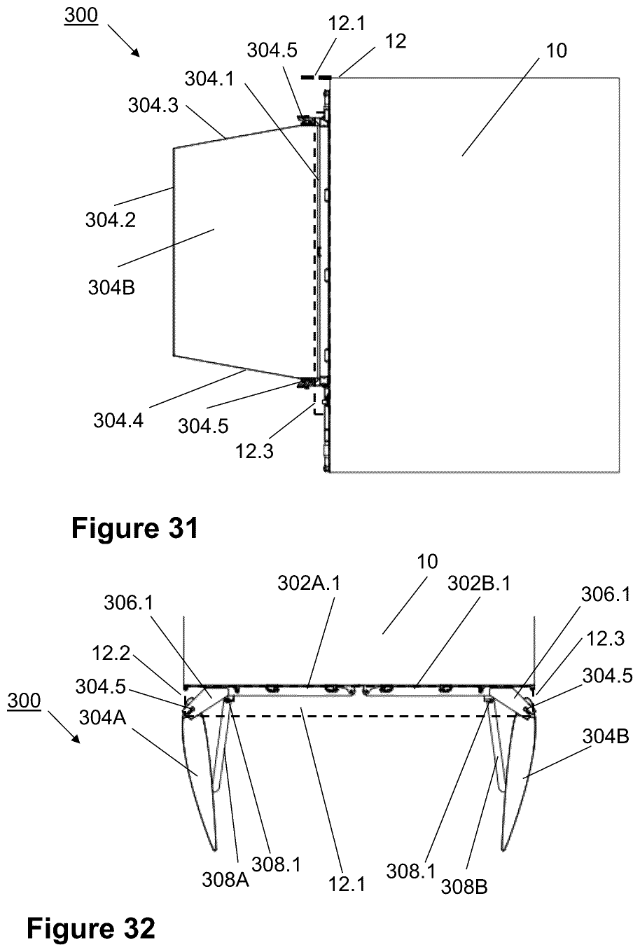

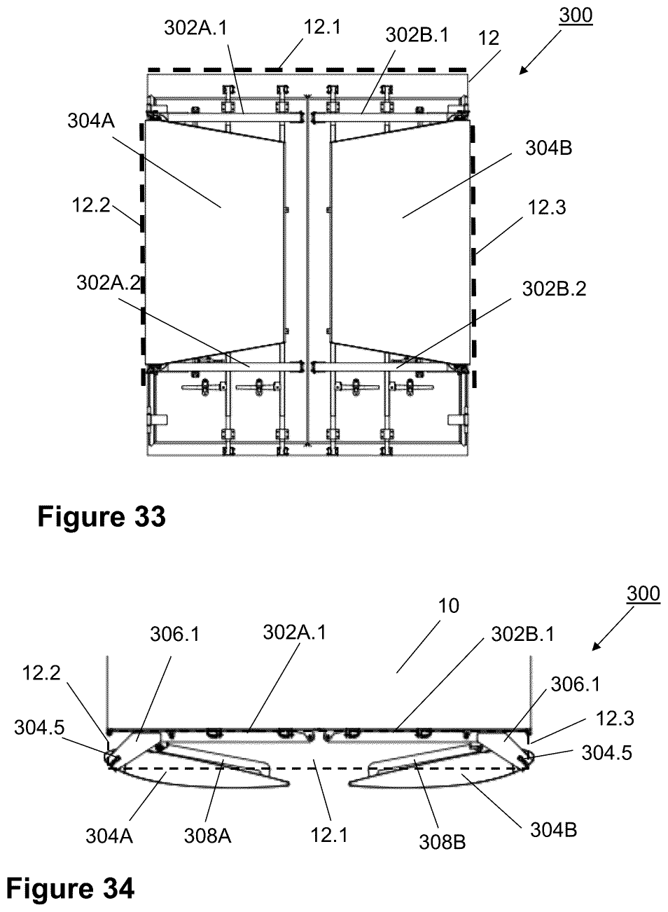

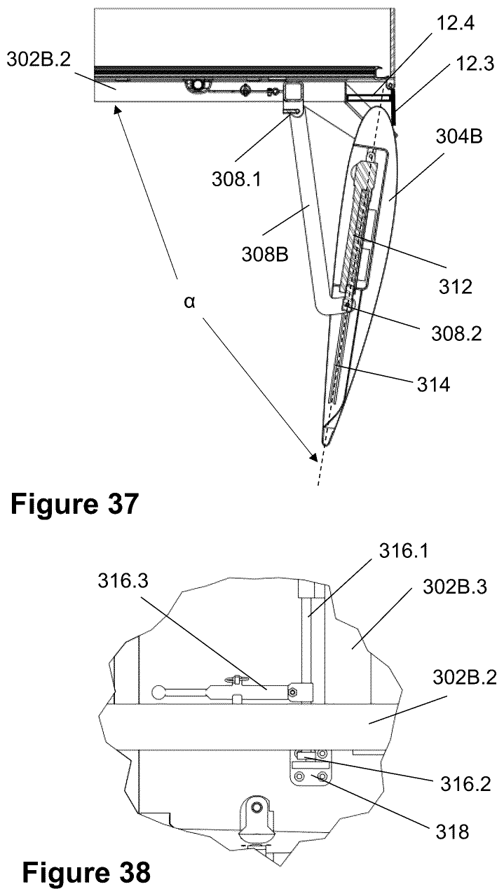

Referring to FIGS. 29 to 42 another embodiment of a fairing system 300 for aft-end drag reduction on a vehicle with a box-shaped enclosure is provided. The system 300 comprises a base which is adapted for being mounted to an aft-end 12 of the box-shaped enclosure 10. Since most box-shaped enclosures 10 comprise a left hand side 14A and right hand side door 14B hingedly mounted to a respective left hand side and right hand side edge of the aft-end 12 of the box-shaped enclosure 10, the base comprises a first base portion 302A.1, 302A.2, 302A.3 and a second base portion 302B.1, 302B.2, 302B.3 adapted for being mounted to the respective left hand side 14A and right hand side door 14B. The base may be provided as a single unit for being mounted to different types of box-shaped enclosures 10 depending on design preferences. A leading edge portion of each of a first and a second wing-shaped body 304A, 304B is pivotally movable mounted to the base via pivots 304.5 disposed in proximity to the respective left hand side and right hand side edge of the box-shaped enclosure 10. Each of the first and second wing-shaped body 304A, 304B is movable between a retracted position, with each of the first and second wing-shaped bodies 304A, 304B being oriented approximately parallel to the aft-end 12 of the box-shaped enclosure 10, and a deployed position, with each of the first and second wing-shaped bodies 304A, 304B being oriented rearwardly and inwardly. Each of a first and a second support strut 308A, 308B is pivotally movable mounted to the base at a first end 308.1 thereof and linearly movable mounted to the respective first and second wing-shaped body 304A, 304B at a second end 308.2 thereof. A first and a second linear actuator 312 is connected to the second end 308.2 of the respective first and second support strut 308A, 308B and mounted to the respective first and second wing-shaped body 304A, 304B. The first and second linear actuator 312 linearly move the second end 308.2 of the respective first and second support strut 308A, 308B between the retracted position and the deployed position.

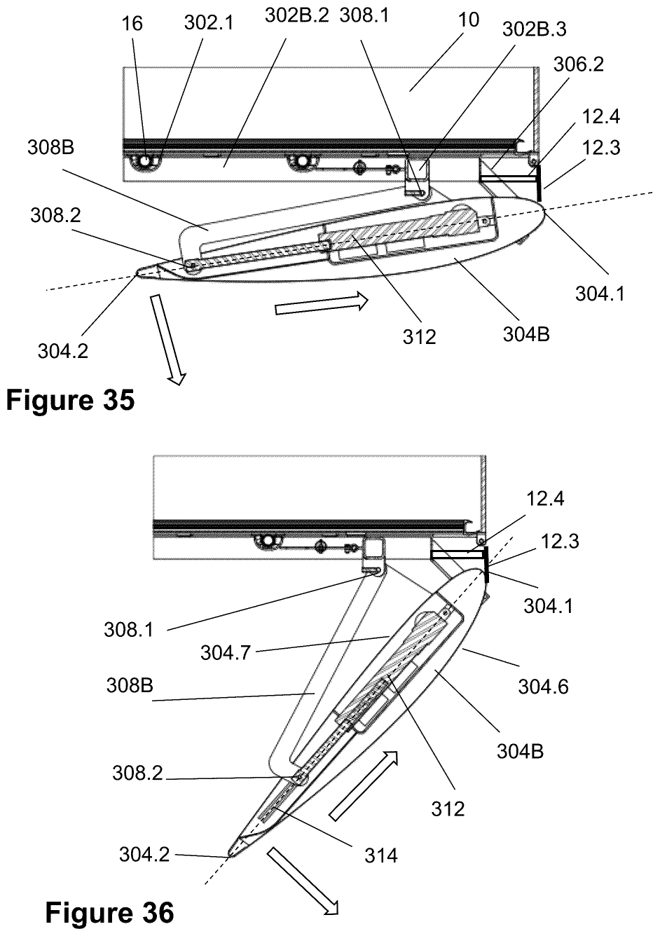

The linear actuators 312 may be disposed inside the first and second wing-shaped body 304A, 304B, as illustrated in FIGS. 35-37. For example, the linear actuators 312 may be placed such that the second end 308.2 of the strut 308A, 308B is moved along guiding rail 314 which is oriented along a line connecting the leading edge 304.1 with the trailing edge 304.2 of the wing-shaped body 304A, 304B, as indicated by the dashed lines in FIGS. 35-37. As the second end 308.2 of the strut 308A, 308B is moved along guiding rail 314 towards the leading edge 304.1 the wing-shaped body 304A, 304B is moved outwardly from the retracted position to the deployed position, as indicated by the block arrows in FIGS. 35-37. In the deployed position, the wing-shaped body 304A, 304B may be oriented at an angle α to the aft-end 12 with the angle α being in the range between 0° and 25°. Optionally, the angle α may be adjustable depending, for example, on the speed of the vehicle. For retracting the wing-shaped bodies 304A, 304B the same process is performed in reverse order. The linear actuator 312 may be provided using a commercially available electric linear actuator such as, for example, VEVOR Linear Actuators. Placing the linear actuator 312 inside the wing-shaped body 304A, 304B has several advantages such as:
minimizing effects on the air flow along the inside surface 304.7 of the wing-shaped body 304A, 304B;
protecting the linear actuator from inclement weather; and,
protecting the linear actuator from dirt and grit thrown up by the rear wheels of the vehicle.

The wing-shaped bodies 304A, 304B may have a convex outside surface 304.6 between the leading edge 304.1 and the trailing edge 304.2 combined with, for example, a flat inside surface, or a convex inside surface 304.7 between the leading edge 304.1 and the trailing edge 304.2. The outside surface 304.6 may be more convex than the inside surface 304.7. Shape and dimensions of the wing-shaped bodies 304A, 304B may be determined in an empirical manner and/or by employing numerical computations for determining the air flow around the wing-shaped bodies 304A, 304B in order to minimize the drag.

Furthermore, the top edge 304.3 of the wing-shaped bodies 304A, 304B may be oriented: rearwardly and downwardly a first predetermined angle in the range between 0° and 45°. Alternatively, the bottom edge 304.4 may be oriented rearwardly and upwardly a second predetermined angle in the range between 0° and 45°. Further alternatively, the top edge 304.3 may be oriented rearwardly and downwardly the first predetermined angle and the bottom edge 304.4 may be oriented rearwardly and upwardly the second predetermined angle with the first angle and the second angle being a same angle or a different angle.

The wing-shaped bodies 304A, 304B may be made of a suitable material that is sufficiently light weight and rigid such as, for example, aluminum sheet material or composite sheet material in a conventional manner.

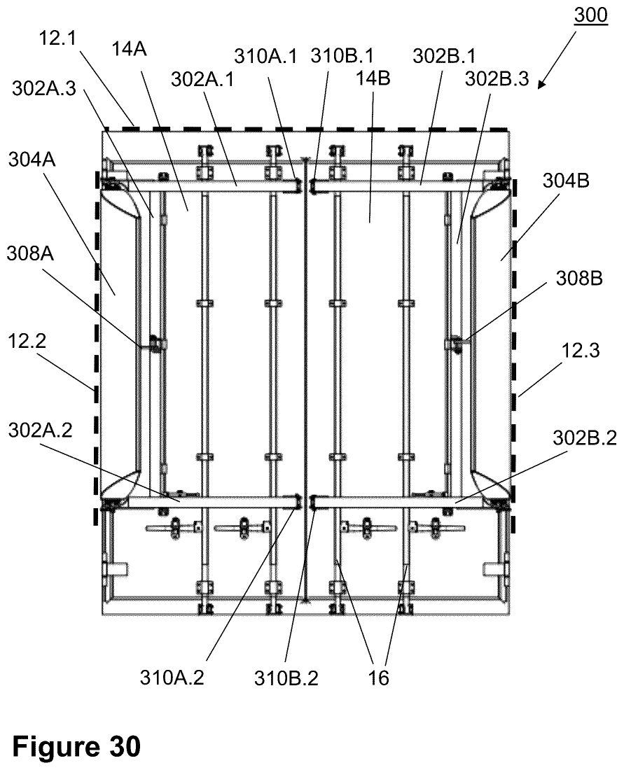

The first and second base portion each may comprise a horizontally oriented top hinge 302A.1, 302B.1 and a horizontally oriented bottom hinge 302A.2, 302B.2 which are pivotally movable mounted to the respective left hand side and right hand side door 14A, 14B at a first end thereof via pivots 310A.1, 310A.2, 310B.1, 310B.2, as illustrated in FIG. 30. The top hinges 302A.1, 302B.1 are fixedly connected to the respective bottom hinges 302A.2, 302B.2 via respective vertically oriented connecting bars 302A.3, 302B.3 in proximity to a distal second end of the top and bottom hinges. The hinges and the connecting bars may be made of commercially available metal tubing such as, for example, steel or aluminum tubing having, for example, a square cross-section. The hinges may be mounted to the respective door via U-shaped mounting elements which are fixedly mounted to the door 14A, 14B. The U-shaped elements and the hinges may comprise matching bores disposed therein for accommodating a locking pin, thus enabling pivotal movement of the hinges, as well as quick and easy assembly/disassembly of the base portions to/from the respective door 14A, 14B.

Optionally, the hinges may comprise cutouts 320.1 for accommodating door locking rods 16 therein, as illustrated in FIG. 35.

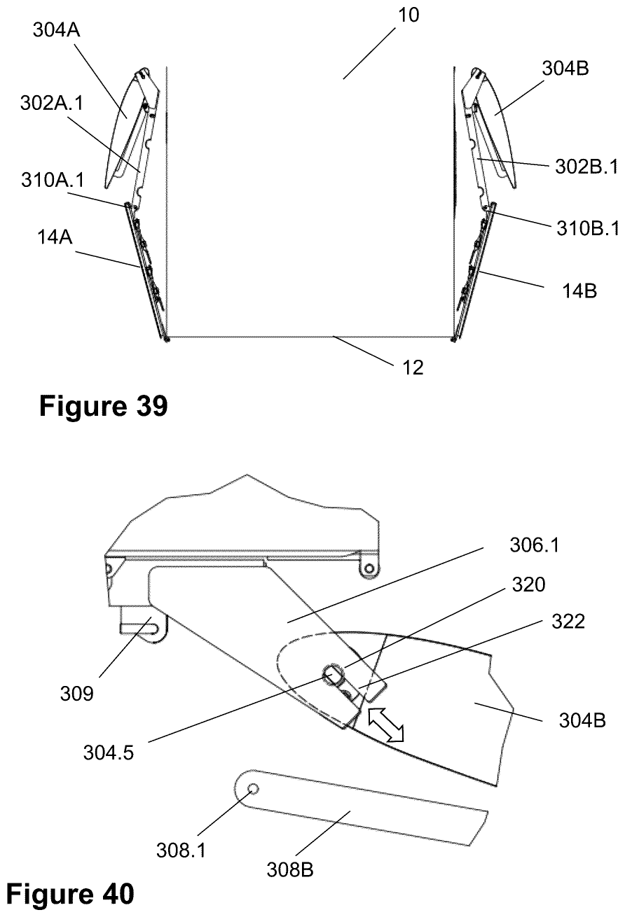

The first and second base portion may be secured to the respective left hand side and right hand side door 14A, 14B using a respective first and second quick lock/release mechanism mounted to the respective first and second base portion in proximity to the connecting bar 302A.3, 302B.3. The first and second quick lock/release mechanism may comprise top and bottom lock/release elements 316.2 which are connected via connecting rod 316.1. The connecting rod 316.1 is pivotally movable mounted to the respective top and bottom hinge 302A.1, 302B.1, 302A.2, 302B.2. Using lever 316.3, the first and second base portion can be easily locked/released by rotating the connecting rod 316.1 for engaging/disengaging the top and the bottom lock/release element 316.2 from the respective mating top and bottom lock/release element 318 fixedly mounted to the door 14A, 14B, as illustrated in the detail in FIG. 38 (only one lock/release element combination 316.2, 318 is shown for simplicity). Provision of the pivotally movable base portions in combination with the quick lock/release mechanism enables the wing-shaped bodies 304A, 304B to be easily and quickly moved from the door 14A, 14B when opening the same and placed along the side the box-shaped enclosure 10 of the vehicle, as illustrated in FIG. 39, thus facilitating backing-up of the vehicle in confined spaces such as, for example, loading bays of warehouses.

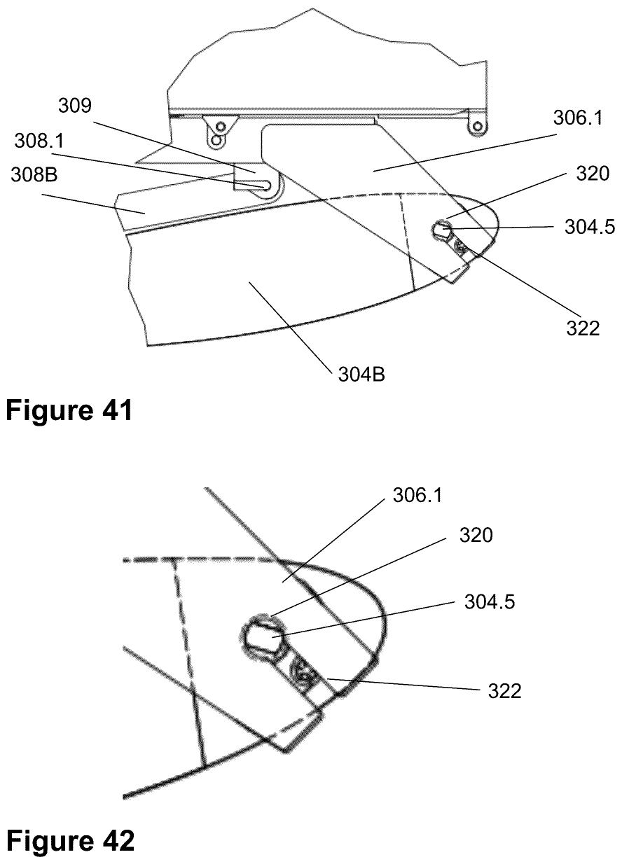

The first and second base portion may further comprise a top and a bottom wing mounting bracket 306.1, 306.2, respectively, extending, for example, from the top and bottom hinge 302A.1, 302B.1, 302A.2, 302B.2. Each of the top and bottom wing mounting bracket 306.1, 306.2 comprises a bore 320 adapted for accommodating pivotally movable therein a respective wing pin 304.5 extending from a top and a bottom end of the wing-shaped body 304A, 304B. Each of the top and bottom wing mounting bracket 306.1, 306.2 may further comprise a channel 322 extending from the bore 320 to an edge thereof with the channel having a width that is smaller than a diameter of the bore 320 to accommodate a wing pin 304.5 having a cross section that corresponds to a remaining area of a circle between two parallel secants such that the pin 304.5 is able to pass through the channel 322 into the bore 320 and rotate therein, as indicated by the block arrow in FIG. 40. The channel 322 may be oriented such that the wing pin 304.5 is prevented from passing through the channel 322 during movement of the wing-shaped body 304A, 304B between the retracted position and the deployed position, as illustrated in FIGS. 41 and 43. This arrangement enables quick assembly of the wing-shaped body 304A, 304B to the base portion by simply passing the wing pins 304.5 through the respective channel 322 into the bore 320 and rotating the wing-shaped body 304A, 304B until the first end 308.1 of the strut 308B can be secured to the respective base portion mounting element 309 using, for example, a locking pin. Once the strut is secured, the wing-shaped body 304A, 304B is enabled to move between the retracted position and the deployed position, but is prevented from disengaging from the wing brackets 306.1, 306.2, as illustrated in FIGS. 41 and 42. For disassembling the wing-shaped body 304A, 304B from the base portion the same process is performed in reverse.

Therefore, the fairing system 300 is easily and quickly mounted to the doors of the enclosure by first inserting the hinges of the base portions into the U-shaped mounting elements and securing the same using locking pins, followed by further securing the base portions to the doors using the quick lock/release mechanism. Once the base portions are fully secured to the respective doors the wing-shaped bodies 304A, 304B are mounted to the respective base portions as described hereinabove. For removing the fairing system 300, the same process is performed in reverse, thus enabling moving of the system 300 from one vehicle to another in a quick and easy manner.

Optionally, top plate 12.1 may be mounted to the aft-end 12 and extend rearwardly up to approximately 4 inches (10 cm) therefrom, as illustrated in FIGS. 29 to 34. Further optionally, side plates 12.2 and 12.3 may be mounted to the first and second base portion, respectively, via mounting elements 12.4, as illustrated in FIGS. 35 to 37. The side plates 12.2 and 12.3 are placed such that they form a continuation of the side edges of the enclosure 10 and are dimensioned such that they approximately cover a gap between the wing-shaped bodies 304A, 304B and the aft-end 12 of the enclosure 10. The plates 12.1-12.3 may be made of commercially available sheet material such as, for example, steel or aluminum sheet material and mounted in a conventional manner.

The fairing system 300 may comprise control circuitry similar to the one illustrated in FIG. 12 but adapted for controlling provision of power to the first and second linear actuator 312 of the fairing system 300. For example, the wing-shaped bodies 304A, 304B are moved into the deployed position when the speed of the vehicle is above a predetermined first threshold speed and are moved into the retracted position when the speed of the vehicle is below a predetermined second threshold speed. Furthermore, the first and second wing-shaped body 304A, 304B may be moved into the retracted position when the speed of the vehicle is below a predetermined second threshold speed for a predetermined period of time.

In another embodiment a fairing system for aft-end drag reduction on a vehicle with a box-shaped enclosure comprises:
a substantially flat base adapted for being mounted to an aft-end of the vehicle; and,
a streamlined body mounted to the base, the streamlined body comprising:
   a first and a second flexible skin forming a first and a second portion of an outer surface of the streamlined body extending rearwardly from the aft-end when deployed and being substantially flat when collapsed;
   a first and a second curved support boom mounted to the first and the second skin, respectively, the support booms being pivotally movable mounted to the base such that the support booms are oriented substantially perpendicular to the base in the deployed position and substantially parallel to the base in the collapsed position; and,
   a first and a second drive mechanism mounted to the base and connected to the first and second support boom, respectively, the drive mechanisms for pivotally moving the respective support booms.

In another embodiment the base comprises a first and a second portion, the first and the second portion being adapted for being mounted to a respective left hand side and right hand side door of the vehicle.

In another embodiment each of the first and the second base portion is adapted for being mounted to the respective left hand side and right hand side door via apertures disposed therein at predetermined locations and bolts placed therethrough.

In another embodiment the bolts are mounted to each of the first and the second base portion and wherein the bolts are screw bolts secured using screw nuts or comprise bores for accommodating a respective quick release pin therethrough.

In another embodiment the streamlined body is adapted to form a dome with approximately a first half of the dome extending rearwardly from the left hand side door and approximately a second half of the dome extending rearwardly from the right hand side door.

In another embodiment each of the first and the second half of the dome comprises at least a curved intermediate support boom mounted to the respective first and second skin and pivotally movable mounted to the respective first and second base.

In another embodiment each of the first and the second flexible skin comprises:
a substantially flat bottom portion mounted to the respective first and second base portion;
a curved top portion forming the outer surface of the respective first and second half of the dome; and,
a substantially flat wall portion connected to the respective bottom portion and top portion such that the wall is oriented substantially perpendicular to the bottom portion when deployed and wherein each of the first and the second flexible skin forms a substantially airtight enclosure;
or,
a respective inner skin oriented substantially parallel thereto at a predetermined distance and wherein each of the first and the second flexible skin together with the respective inner skin forms a substantially airtight enclosure.

In another embodiment the system comprises means for providing pressurized air connected to each of the first and the second flexible skin.

In another embodiment each of the a first and the second flexible skin comprises at least a tether mounted thereto for providing rigidity to the respective first and second half of the dome.

In another embodiment the system further comprises at least a processor connected to the first and the second drive mechanism and connected to a speed sensor, the at least a processor being adapted for receiving data indicative of a speed of the vehicle and for providing power to the first and the second drive mechanism in dependence thereupon.

In another embodiment the system further comprises a temperature sensor connected to the at least a processor, the temperature sensor for sensing an ambient temperature and providing temperature data in dependence thereupon, and wherein the at least a processor is adapted for providing power to the first and the second drive mechanism in dependence upon the temperature data.

In another embodiment the system further comprises:
a temperature sensor connected to the at least a processor, the temperature sensor for sensing an ambient temperature and providing temperature data in dependence thereupon; and,
means for preventing ice-buildup on the outer surface of the streamlined body connected to the processor; and,
wherein the at least a processor is adapted for providing power to the means for preventing ice-buildup in dependence upon the temperature data.

In another embodiment a method for reducing aft-end drag on a vehicle with a box-shaped enclosure comprises:
providing a fairing system comprising:
   a substantially flat base adapted for being mounted to an aft-end of the vehicle;
   a streamlined body mounted to the base, the streamlined body comprising:
      a first and a second flexible skin forming a first and a second portion of an outer surface of the streamlined body extending rearwardly from the aft-end when deployed and being substantially flat when collapsed;
      a first and a second curved support boom mounted to the first and the second skin,
      respectively, the support booms being pivotally movable mounted to the base such that the support booms are oriented substantially perpendicular to the base in the deployed position and substantially parallel to the base in the collapsed position;
      a first and a second drive mechanism mounted to the base and connected to the first and second support boom, respectively, the drive mechanisms for pivotally moving the respective support booms;
   at least a processor connected to the first and the second drive mechanism and connected to a speed sensor, the at least a processor being adapted for receiving data indicative of a speed of the vehicle and for providing power to the first and the second drive mechanism in dependence thereupon;
moving the first and second support boom into the deployed position when the speed of the vehicle is above a predetermined first threshold speed.

In another embodiment the method further comprises moving the first and second support boom into the collapsed position when the speed of the vehicle is below a predetermined second threshold speed.

In another embodiment the method further comprises moving the first and second support boom into the collapsed position when the speed of the vehicle is below a predetermined second threshold speed for a predetermined period of time.

In another embodiment the fairing system comprises a temperature sensor connected to the at least a processor, the temperature sensor for sensing an ambient temperature and providing temperature data in dependence thereupon; and,
wherein the first and second support boom are being prevented from being moved into the deployed position when the ambient temperature is below a predetermined threshold temperature.

In another embodiment the first and second support boom are moved into the collapsed position when the ambient temperature is below a predetermined threshold temperature.

In another embodiment the first and second support boom are moved into the collapsed position when the ambient temperature is below a predetermined threshold temperature for a predetermined period of time.

In another embodiment the fairing system comprises
a temperature sensor connected to the at least a processor, the temperature sensor for sensing an ambient temperature and providing temperature data in dependence thereupon; and,
means for preventing ice-buildup on the outer surface of the streamlined body connected to the processor; and,
wherein the means for preventing ice-buildup is activated when the ambient temperature is below a predetermined threshold temperature.

In another embodiment the means for preventing ice-buildup is activated when the ambient temperature is below a predetermined threshold temperature for a predetermined period of time.

In another embodiment a fairing system for aft-end drag reduction on a vehicle with a box-shaped enclosure comprises:
a substantially flat base adapted for being mounted to an aft-end of the vehicle;
a first and a second wing-shaped body, a leading edge portion of each of the first and the second wing-shaped body being pivotally movable mounted to the base in proximity to a respective left hand side edge and right hand side edge of the vehicle such that each of the first and the second wing-shaped body is movable between a retracted position with the first and the second wing-shaped body being oriented substantially parallel to the aft-end of the vehicle and a deployed position with the first and the second wing-shaped body being oriented rearwardly and inwardly, and wherein the leading edge portion of each of the first and the second wing-shaped body is placed such that there is a predetermined gap between the same and the aft-end of the vehicle for enabling an airflow therethrough and along an inside surface of each of the first and the second wing-shaped body; and,
a support structure mounted to the base and each of the first and the second wing-shaped body, the support structure for securing the first and the second wing-shaped body to the base and for enabling moving of the first and the second wing-shaped body between the retracted position and the deployed position.

In another embodiment the base comprises a first and a second portion, the first and the second portion being adapted for being mounted to a respective left hand side and right hand side door of the vehicle.

The present invention has been described herein with regard to preferred embodiments. However, it will be obvious to persons skilled in the art that a number of variations and modifications can be made without departing from the scope of the invention as described herein.

What is claimed is:

1. A fairing system for aft-end drag reduction on a vehicle with a box-shaped enclosure comprising:
a base adapted for being mounted to an aft-end of the box-shaped enclosure;
a first and a second wing-shaped body, a leading edge portion of each of the first and second wing-shaped body being pivotally movable mounted to the base in proximity to a respective left hand side and right hand side edge of the box-shaped enclosure such that each of the first and second wing-shaped body is movable between a retracted position with each of the first and second wing-shaped body being oriented approximately parallel to the aft-end of the box-shaped enclosure and a deployed position with each of the first and second wing-shaped body being oriented rearwardly and inwardly;
a first and a second support strut pivotally movable mounted to the base at a first end thereof and linearly movable mounted to the respective first and second wing-shaped body at a second end thereof; and,
a first and a second linear actuator connected to the second end of the respective first and second support strut, the first and second linear actuator being mounted to the respective first and second wing-shaped body, the first and second linear actuator for linearly moving the second end of the respective first and second support strut between the retracted position and the deployed position.

2. The fairing system of claim 1 wherein the base comprises a first and a second base portion, the first and second base portion being adapted for being mounted to a respective left hand side and right hand side door of the box-shaped enclosure.

3. The fairing system of claim 2 wherein each of the first and second linear actuator is disposed inside the respective first and second wing-shaped body.

4. The fairing system of claim 2 wherein the left hand side and right hand side door are pivotally movable mounted to the respective left hand side and right hand side edge of the box-shaped enclosure and wherein the first and second base portion are pivotally movable mounted in proximity to a distal edge of the respective left hand side and right hand side door.

5. The fairing system of claim 4 wherein the first and second base portion are secured to the respective left hand side and right hand side door in proximity to a proximal edge thereof.

6. The fairing system of claim 5 wherein the first and second base portion are secured to the respective left hand side and right hand side door using a respective first and second quick lock/release mechanism.

7. The fairing system of claim 6 wherein the first and second base portion each comprise a top and bottom hinge pivotally movable mounted to the respective left hand side and right hand side door at a first end thereof and wherein the top and bottom hinge are connected via a connecting bar in proximity to a distal second end of the top and bottom hinge.

8. The fairing system of claim 7 wherein each of the first and second quick lock/release mechanism is mounted the respective first and second base portion in proximity to the connecting bar.

9. The fairing system of claim 8 wherein each of the first and second quick lock/release mechanism comprises a top and a bottom lock/release element and wherein the top and bottom lock/release element are connected via a connecting rod that is pivotally movable mounted to the respective top and bottom hinge.

10. The fairing system of claim 2 wherein each of the first and second base portion comprises a top and a bottom wing mounting bracket extending therefrom with each of the top and bottom wing mounting bracket comprising a bore adapted for accommodating pivotally movable therein a respective wing pin extending from a top and a bottom end of the wing-shaped body.

11. The fairing system of claim 10 wherein each of the top and bottom wing mounting bracket comprises a channel extending from the bore to an edge thereof with the channel having a width that is smaller than a diameter of the bore and wherein each wing pin has a cross section that corresponds to a remaining area of a circle between two parallel secants such that the pin is able to pass through the channel into the bore and rotate therein.

12. The fairing system of claim 11 wherein the channel is oriented such that the wing pin is prevented from passing through the channel during movement of the wing-shaped body between the retracted position and the deployed position.

13. The fairing system of claim 11 wherein each of the first and second wing-shaped body comprises a convex outside surface between a leading edge and a trailing edge thereof.

14. The fairing system of claim 13 wherein each of the first and second wing-shaped body comprises a convex inside surface between the leading edge and the trailing edge thereof.

15. The fairing system of claim 14 wherein the outside surface is more convex than the inside surface.

16. The fairing system of claim 12 wherein each of the first and second wing-shaped body comprises:
a top edge that is oriented rearwardly and downwardly; or
a bottom edge that is oriented rearwardly and upwardly; or
a top edge that is oriented rearwardly and downwardly and a bottom edge that is oriented rearwardly and upwardly.

17. The fairing system of claim 2 comprising at least a processor connected to the the first and second linear actuator and connected to a speed sensor, the at least a processor being adapted for receiving data indicative of a speed of the vehicle and for controlling provision of power to the first and second linear actuator in dependence thereupon.

18. A method for reducing aft-end drag on a vehicle with a box-shaped enclosure comprising:
providing a fairing system comprising:
a base adapted for being mounted to an aft-end of the box-shaped enclosure;
a first and a second wing-shaped body, a leading edge portion of each of the first and second wing-shaped body being pivotally movable mounted to the base in proximity to a respective left hand side and right hand side edge of the box-shaped enclosure such that each of the first and second wing-shaped body is movable between a retracted position with each of the first and second wing-shaped body being oriented approximately parallel to the aft-end of the box-shaped enclosure and a deployed position with each of the first and second wing-shaped body being oriented rearwardly and inwardly;
a first and a second support strut pivotally movable mounted to the base at a first end thereof and linearly movable mounted to the respective first and second wing-shaped body at a second end thereof;
a first and a second linear actuator connected to the second end of the respective first and second support strut, the first and second linear actuator being mounted to the respective first and second wing-shaped body, the first and second linear actuator for linearly moving the second end of the respective first and second support strut between the retracted position and the deployed position; and,
at least a processor connected to the first and second linear actuator and connected to a speed sensor, the at least a processor being adapted for receiving data indicative of a speed of the vehicle and for controlling provision of power to the first and second linear actuator in dependence thereupon;
and,
moving the first and second wing-shaped body into the deployed position when the speed of the vehicle is above a predetermined first threshold speed.

19. The method of claim 18 comprising moving the first and second wing-shaped body into the retracted position when the speed of the vehicle is below a predetermined second threshold speed.

20. The method of claim 18 comprising moving the first and second wing-shaped body into the retracted position when the speed of the vehicle is below a predetermined second threshold speed for a predetermined period of time.
